(19) United States
(12) Patent Application Publication
(10) Pub. No.: US 2002/0156814 A1
(43) Pub. Date: Oct. 24, 2002

(54) Method and apparatus for visual business computing

(76) Inventor: Bruce K. Ho, Irving, CA (US)

Correspondence Address: BEYER WEAVER & THOMAS LLP, P.O. BOX 778, BERKELEY, CA, 94704-0778, US

(21) Appl. No.: 09/836,926

(22) Filed: Apr. 17, 2001

Related U.S. Application Data
(60) Provisional application No. 60/198,344, filed on Apr. 18, 2000.
(60) Provisional application No. 60/035,477, filed on Jan. 13, 1997.
(60) Provisional application No. 60/219,284, filed on Jul. 19, 2000.
(60) Provisional application No. 60/238,553, filed on Oct. 10, 2000.

(51) Int. Cl. G06F 17/21

(52) U.S. Cl. 707/514; 707/501.1

(57) ABSTRACT

A computer readable medium containing program instructions for providing data to a web page is provided. Computer readable code allows a user to form a hierarchical tree comprising a plurality of nodes. Computer readable code allows the user to select a node from the hierarchical tree, wherein the selected node has at least one attribute. Computer readable code allows a user to bind the at least one attribute to the web page.

A computer readable medium containing program instructions for managing a network of computers is provided. A computer readable code allows a user to form a hierarchical tree comprising a plurality of nodes. A computer readable code allows a user to bind nodes of the hierarchical tree.

### RELATED APPLICATIONS

This application claims priority under 35 USC 119(e), to the provisional application No. 60/198,344 entitled “Method and System for Automating Implementation of E-business Solutions,” which was filed on Apr. 18, 2000, provisional application, attorney docket no LB-102P entitled “E-business Integration Framework,” which was filed on Jun. 12, 2000, provisional application No. 60/219,284 entitled “Third Party Server Control And Manipulation of Web Page Content and Behavior,” which was filed on Jul. 19, 2000, and provisional application No. 60/238,553 entitled “Double Helix Architecture E-business Integration,” which was filed on Oct. 10, 2000, where all four provisional applications are hereby incorporated by reference.

### BACKGROUND OF THE INVENTION

The present invention relates to business computing. More particularly, the invention relates to a visual business computing system.

Implementation of business computer systems commonly is based on a three tier architecture. To facilitate understanding, FIG. 1 is a schematic view of the three tier architecture that may be used in the prior art. Such an architecture would have a presentation layer 104, a business logic layer 108, and a database 112. Commonly, these three layers may use fundamentally different data representations, programming languages, development environments, and implementation skill sets. Business computer systems, which use these three layers, may require effort to patch up the so called “impedance matching” between the presentation layer 104 and the business logic layer 108 and between the business logic layer 108 and the database layer 112.

FIG. 2 is a schematic illustration of how a company 200 may use database systems in the prior art. The company 200 may have many different departments. In this example, the sales department 202, the shipping department 204, and the billing department 206 are shown. Each of these departments 202, 204, 206 is shown to have a packaged application systems 208, 210, 212. Packaged application systems may be proprietary computer systems that allow a department to automate some of the department's work. Some examples of application systems are SAP systems by SAP AGTM of Germany, Baan systems by Baan™ of the Netherlands, and Siebel systems by Siebel Systems Inc.™ of San Mateo, Calif. In this example the sales department 202 has a first packaged application 208, the shipping department 204 has a second packaged application system 210, and the billing department 206 has a third packaged application system 212. In this example, the first packaged application system 208, the second packaged application system 210, and the third packaged application system 212 are all different from each other (disparate systems).

Typically, each packaged application system would have a database. Examples of databases for application system packages would be Oracle databases by Oracle Corporation™ of Redwood Shores Calif., a proprietary IBM database by International Business Machines Corporation™ of White Plains N.Y. In this example, the database 214 of the first packaged application system 208 is different from the database 216 of the second packaged application system 210, which is different from the database 218 of the third packaged application system 212.

The arrow 220 represents the work flow, which may represent the flow of information between departments for a given project. In some companies, the first packaged application system 208, the second packaged application system 210, and the third packaged application system 212 may not have been able to communicate with each other. As a result, to accomplish the work flow 220, a user 222 in the sales department 202 may obtain a hard copy print out from the first packaged application system 208. The user 222 may hand the hardcopy to a user 224 in the shipping department 204. The user 224 in the shipping department 204 may enter some of the data from the hard copy into the second packaged application 210, which may then print out a hard copy report for the user 224 in the shipping department 204. The user 224 in the shipping department 204 may then hand the hard copy report to a user 226 in the billing department 206. The user 226 in the billing department 206 may enter some of the data from the hard copy into the third packaged application 212, which may then provide information to the user 226 in the billing department 206, which is the goal of the work flow 220. Such a system requires much manual work by the users 222, 224, 226. In addition, often redundant data must be stored in the databases 214, 216, 218, since the packaged application systems 208, 210, 212 are not able to share data. If a company executive wants different data a new work flow may be created, which would require instructing the users to change their actions to achieve new results.

FIG. 3 is a schematic illustration of the company 200 where middleware 332, 334 has been added between the first packaged application 208 and the second application 210 and between the second package application 210 and the third packaged application 212. Some examples of middleware are Vitria, Tibco, Mercator, Extricity, and NEON Middleware, which may allow different package applications to exchange data. The exchange of data between packaged applications 208, 210, 212 using middleware may allow the users 222, 224, 226 to avoid exchanging hard copies and re-entering information already on one of the packaged applications 208, 210, 212.

Middleware software may be uniquely tailored to the data structure, calls, and puts of each of two particular packaged applications to allow data to be transmitted between the two particular packaged applications. Middleware has had some problems. When translations between three or more packaged applications are desired, middleware often is not able to accomplish this. Trying to provide translations between three or more packaged applications tends to cause middleware to lose its functionality. Even when only used between two packaged applications often, middleware has not been able to provide a perfect transfer of data between two particular packaged applications. This may require that a person continuously monitor the translation between packaged applications to make sure that the translations are correct. To decrease translation errors, more middleware applications may be required, which may also cause the middleware to slow down the system.

Some of these middleware companies merged their businesses to have the ability to interface with more systems even though were not originally designed to work together. Competing products may have been merged together in an attempt to allow three or more different packaged applications to be able to communicate with each other. Such merging may require different middleware products to attempt to communicate with each other. The differences in middleware may cause difficulty in communications between middleware, which may provide translation errors between packaged applications.

In addition, if the database 214 of the first packaged application system 208 is different from the database 216 of the second packaged application system 210, which is different from the database 218 the middleware may need to know the formatting of the databases 214, 216, 218 and may need to be able to reformat data translated between databases 214, 216, 218. Such translation may provide errors, which may require additional human monitoring. Providing a translation between databases may not automatically reduce redundancy. As a result, translation between the databases 214, 216, 218 may still require that each database has complete records of a client, client address, client phone number, and other client information and may require redundant entry of the same data into different packaged applications. In order to provide business logic, i.e. write function calls or programs that use the data from the first, second, and third packaged application 208, 210, 212 a program may need to take into account the characteristics of the first, second, and third packaged applications 208, 210, 212, the middleware 332, 334, and the databases 214, 216, 218, which may make providing business logic for the company a very complex task, which may required a skilled programmer. For example, to update a client's phone number, a program may need to understand the first packaged application system 208 and its database 214 to provide a command to update the clients phone number for the first packaged application system and to understand the second packaged application system 210 and its database 216 to provide a command to update the client's phone number for the second packaged application system, and to understand the third packaged application system 212 and its database 218 to provide a command to update the clients phone number for the third packaged application system.

In view of the foregoing, it would be desirable to provide an architecture that reduces or eliminates impedance mismatching allowing for better communication between different packaged applications systems and their database, simplifying the implementation of companies business logic.

### SUMMARY OF THE INVENTION

The invention relates, in one embodiment, to a computer readable medium containing program instructions for providing data to a web page. Computer readable code allows a user to form a hierarchical tree comprising a plurality of nodes. Computer readable code allows the user to select a node from the hierarchical tree, wherein the selected node has at least one attribute. Computer readable code allows a user to bind the at least one attribute to the web page.

In another embodiment of the invention, a computer readable medium containing program instructions for managing a network of computers is provided. A computer readable code allows a user to form a hierarchical tree comprising a plurality of nodes. A computer readable code allows a user to bind nodes of the hierarchical tree.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic view of the three tier architecture that may be used in the prior art.

FIG. 2 is a schematic illustration of how a company may use database systems in the prior art.

FIG. 3 is a schematic illustration of the company where middleware has been added.

FIG. 4 is a high level logical view of a preferred embodiment of the invention.

FIG. 5 is a high level schematic view of an implementation of the system illustrated in FIG. 4.

FIG. 6 is a high level flow chart of the steps used in the invention.

FIG. 7 is an example illustration of an interface called an architect room.

FIG. 8 is an illustration of a service chain.

FIG. 9 is a schematic illustration of how service chains and a content architect ay be bound in a preferred embodiment of the invention.

FIG. 10 is a schematic view of an enterprise system with a content wrapper.

FIG. 11 is a schematic illustration of various user interfaces provided by a referred embodiment of the invention.

FIG. 12 is an illustration of another architect room interface, where only four ab panels are shown.

FIG. 13 is a first view of a window for a type room interface.

FIG. 14 is a second view of a window for a type room interface.

FIG. 15 is a third view of a window for a type room with a form to allow the entry of an attribute.

FIG. 16 is a view of an architect room window, which is set to create a new service.

FIG. 17 is another view of an architect room window.

FIG. 18 is an illustration of a press room GUI.

FIG. 19 is an illustration of a web page that is loaded on a web browser.

FIG. 20 is an illustration of a war room GUI.

FIG. 21 is an example of a resulting rule GUI.

FIGS. 22A and 22B illustrate a computer system.

FIG. 23 is a high level flow chart of the page binding process in a preferred embodiment of the invention.

FIG. 24 is a schematic illustration of part of a content architect tree.

FIG. 25 is a schematic illustration of a web page that is to be page bound.

FIG. 26 is a schematic view of a link.

FIG. 27 is an example of a service chain that illustrates multiple level dependencies.

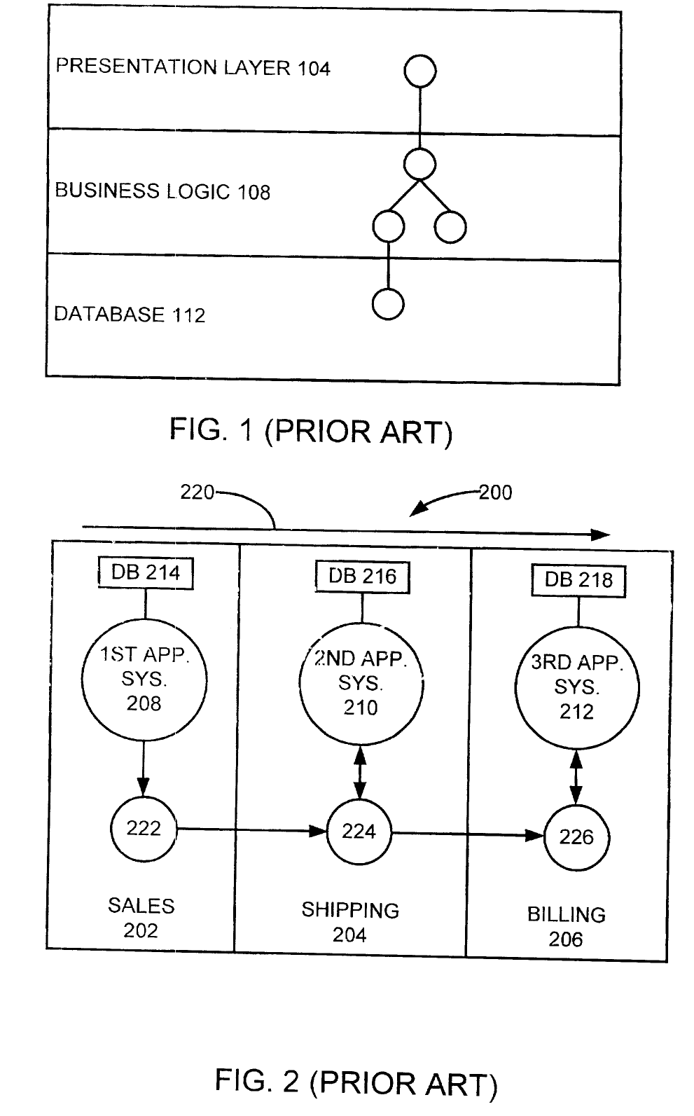

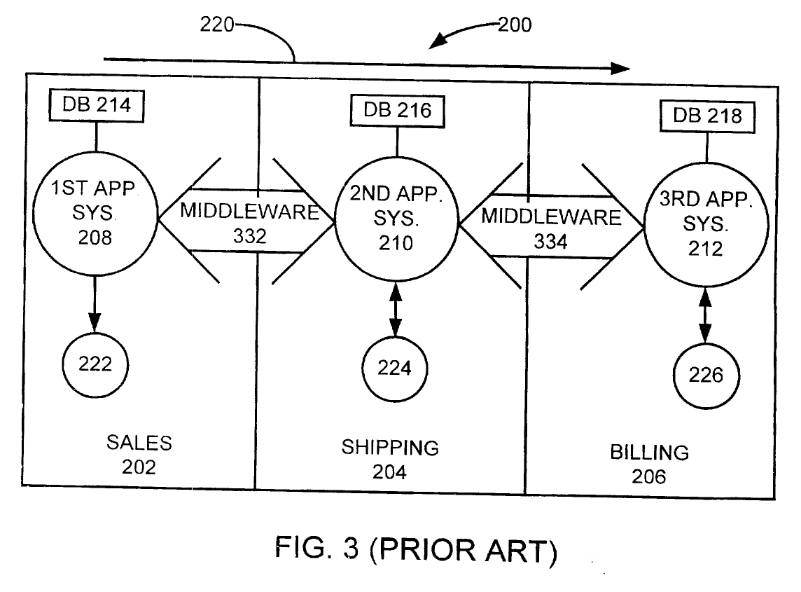

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well-known process steps and/or structures have not been described in detail in order not to unnecessarily obscure the present invention.

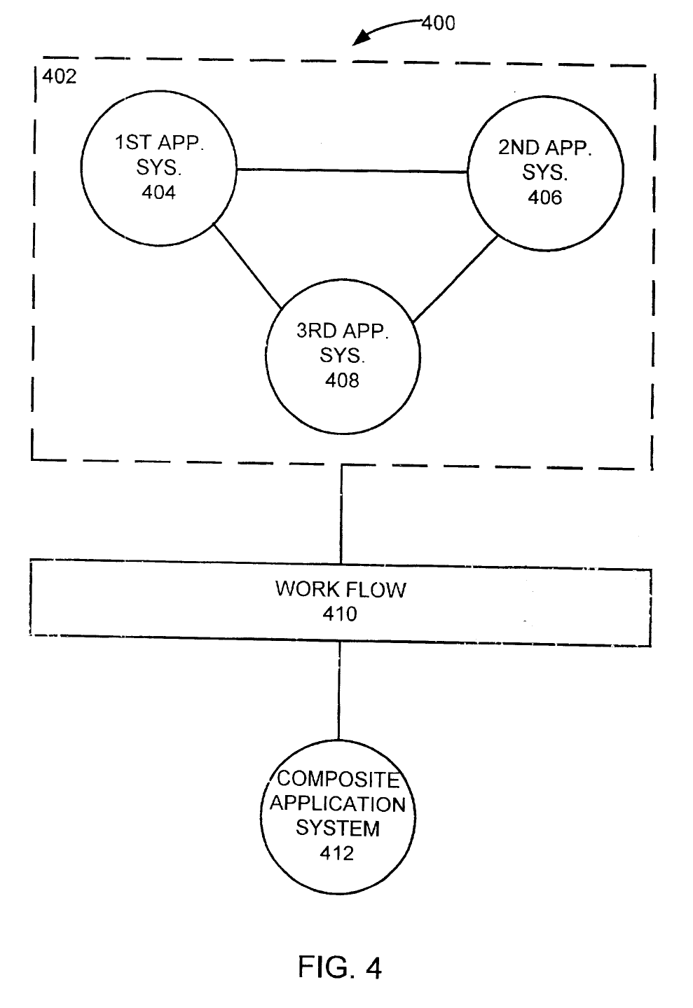

To facilitate understanding, FIG. 4 is a high level logical view of a preferred embodiment of the invention. In FIG. 4 a company enterprise system 400 comprises a first packaged applications system 404, a second packaged application system 406, and a third packaged application system 408. The invention allows the first packaged application system 404, second packaged application system 406, and third packaged application system 408 to operate as a single system, which may be seen as a black box 402. The black box 402 allows the first, second, and third packaged application systems 404, 406, 408 to be used as a single engine where a user does not need to be aware of the individual first, second, and third packaged application systems 404, 406, 408.

A composite application system 412 with a user interface provides access to the first, second, and third packaged application systems 404, 406, 408 as the black box 402.

Work flow 410 is a group of business process rules for performing business related processes on data. Work flow rules change according to the information desired by the company 400. In the preferred embodiment, these rules would not be related to how information is stored in the black box 402.

Generally, the information technology department of the company 400 would write the composite applications (business logic) for the composite application system 412 while executives of the company may dictate the work flow rules (business process) for the work flow 410. The ability to integrate different packaged applications (disparate systems) into a common virtual system where all aspects of the enterprise computing is tied together so that it appears as a unified application is called a composite application development.

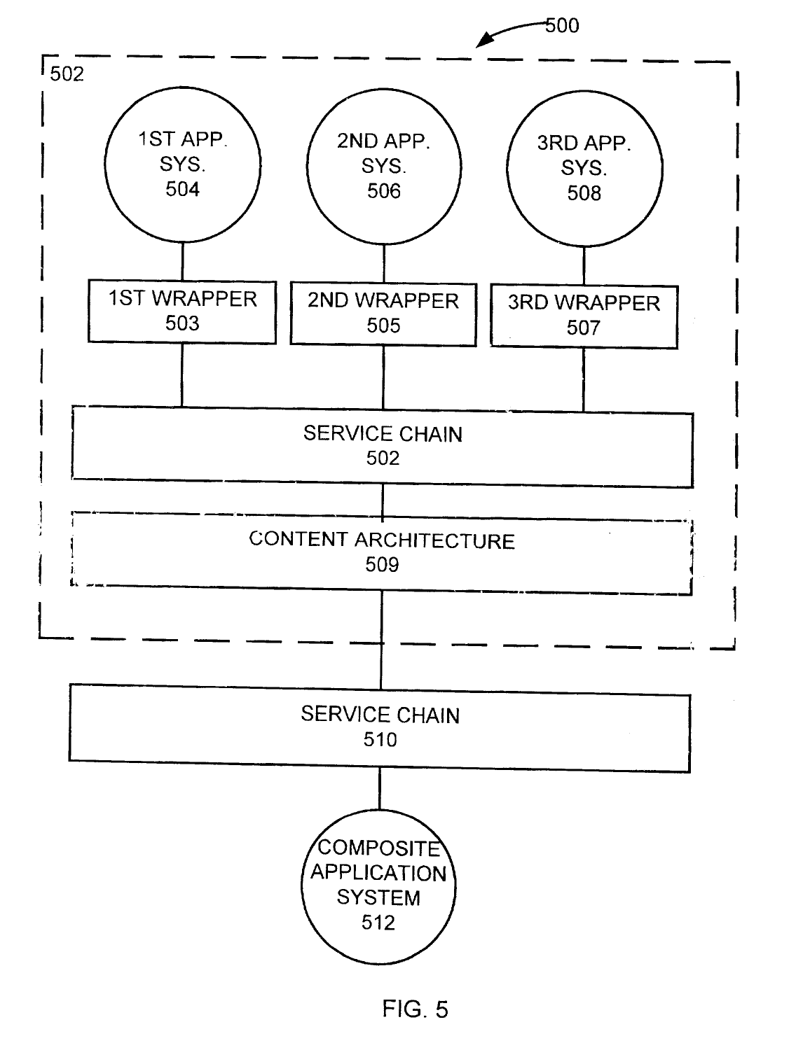

FIG. 5 is a high level schematic view of an implementation of the system illustrated in FIG. 4 in the preferred embodiment of the invention. A company enterprise system 500, comprises a black box 502 with first, second, and third packaged applications 504, 506, 508. For example, the first packaged application system 504 may be for may be a packaged application for a sales department, the second packaged application system 506 may be for a shipping department, and the third packaged application system 508 may be for a billing department. A content architect 509 is an additional data structure that allows the use of the first, second, and third packaged application system 504, 506, 508 as a black box 502. A first service chain 502 provides some translation between the first packaged application system 504 and the content architect 502. A first wrapper 503 provides additional translation between the first packaged application 504 and the content architect 509. The first service chain 502 provides some translation between the second packaged application system 506 and the content architect 502. A second wrapper 505 provides additional translation between the second packaged application 506 and the content architect 509. The first service chain 502 provides some translation between the third packaged application system 508 and the content architect 502. A third wrapper 507 provides additional translation between the third packaged application 508 and the content architect 509. A second service chain 5 10 and a composite application system 512 are connected to the content architect that stores and mirrors data in integrated systems within a company. This makes three separate wrapper layers which behave like a content architect. The service chain 5 10 contains a business process rule and the composite application system 512 contains the business logic.

In the preferred embodiment, the content architect 509 is in-memory program objects in the form of a hierarchical tree, which captures the organization and details of all types of business information. This is essentially an all encompassing modeling framework, which automates content entry, persistence, and delivery. Content captured by this structure can be persisted either by automatically generated relational tables or via interfaces to all kinds of existing backend systems, including packaged applications. Because persistence is automatic, the designer does not have to ever worry about the underlying database issues. A content architect tree can also be populated from an external data store, such as business backend systems like SAP, PeopleSoft, and etc. backends.

A good example of a content architect application is a catalog server. A clothing retailer would organize all of its numerous offerings along brand name, product lines, specialties, and maybe seasonal differentiations. This categorization is explicit in the organization of the content architect (the tree form). Each leaf node in the tree would represent a product item, which is described by product attributes. All descriptions of the items as well as their categories are extracted from either automatically generated persistence layer, or pre-existing data stores.

The content architect has a robust attribute inheritance capability, which gives it powerful ability to capture complex information structures such as a telecom gear product catalog. This means that a product has both its own attributes as well as attributes of all its ancestors along the inheritance tree. A manufacturer icon, for example, can now show up in every product page under this manufacturer, without explicitly making it a product attribute.

In the preferred embodiment of the invention, the content architect restricts the object types according to web specifications. Preferably, the object types include text, anchor, image, list, table, and bag, which can be a combination of other object types. By restricting the object types, the content architect is able to avoid manual coding to reformat data from different forms semantically as they traverse between storage and logic layer in software, since the restrained objects in the content architect may be stored in a fully automated fashion.

In the preferred embodiment, the content architect comprises persistent trees and dynamic trees. Persistent trees are populated by hand or can be read from a web site and or a data base through a service chain and are explicitly published to be persistent. Dynamic trees are populated by service chains at run time and are not stored in the database. Persistent trees are equivalent to database storage in traditional programming. They define the type of data required to run any application. Dynamic trees are like the different views an application shows the user. Each view requires a new dynamic tree.

The service chain 510 comprises a group of application functions in the form of objects. Preferably the service chain 510 comprises a group of objects that can take care of all ebusiness requirements for development, to eliminate 90% of the programming normally used when building such business programs from scratch.

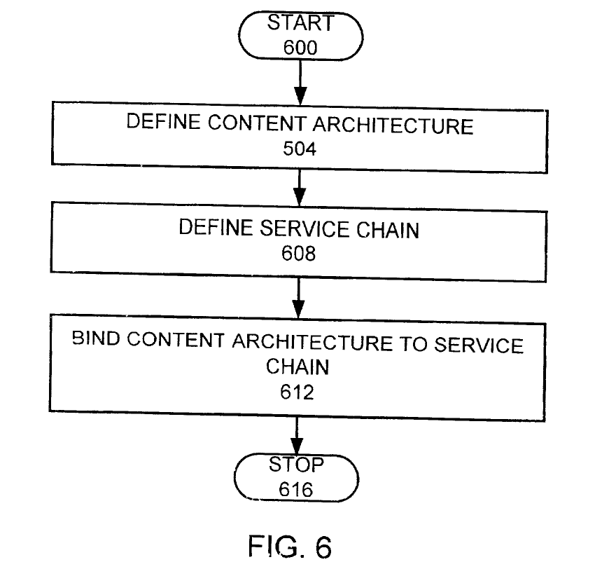

Although the service chain 510, composite application system 512, and content architect allow executives to use company wide data for business processes, the first packaged application system 504 may still be used by the sales department to provide specialized sales computations. To facilitate understanding, FIG. 6 is a high level flow chart of the steps used in the invention. In FIG. 6 the content architect 509 is defined (step 604). The service chain 510 is also defined (step 608). A node of the content architect 509 is bound to the service chain 510 (step 612). These steps may be done sequentially, where either the content architect or service chain are defined first. These steps may also be done simultaneously or parts of these steps may be done in alternating order.

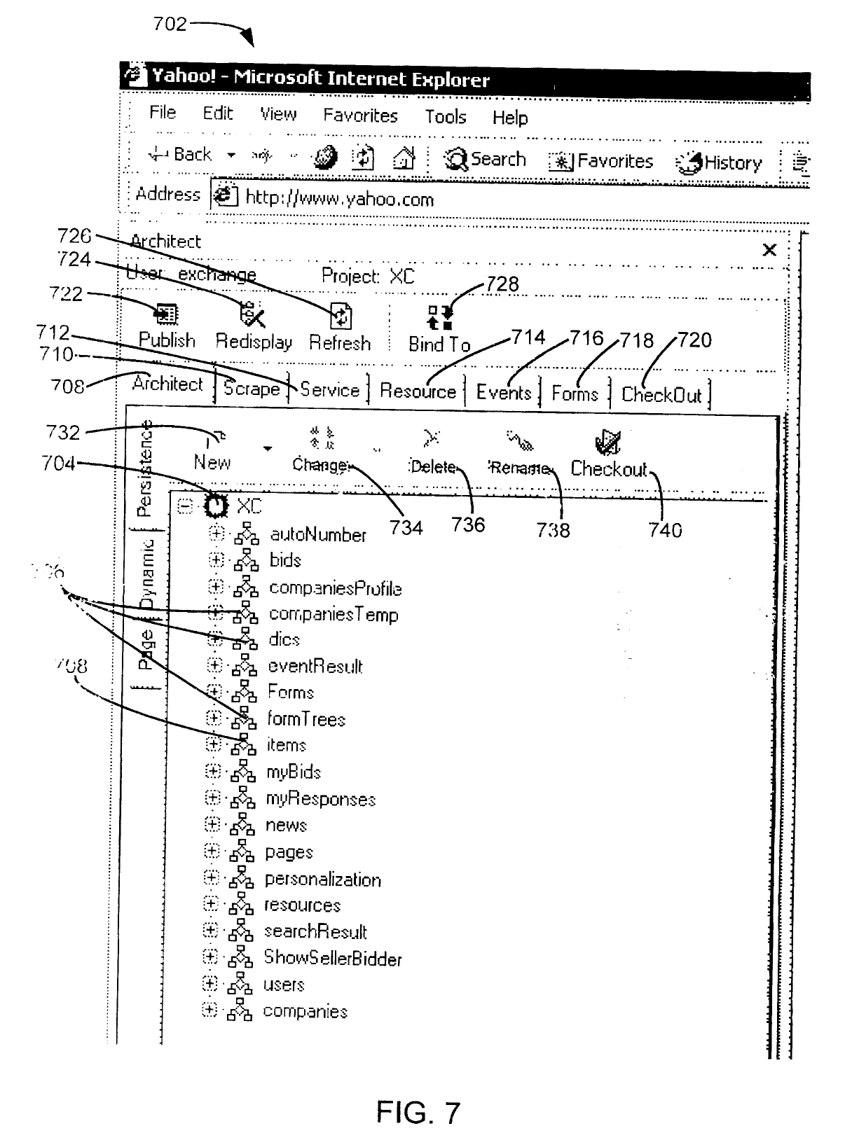

FIG. 7 is an example illustration of an interface called an architect room 702, which may be used to define the content architect 509 (step 604). In this example, a project 704 named XC has a plurality of hierarchical trees 706, which form the content architect 509 and where the project is the top node. In this example, a standard Internet browser, such as Internet Explorer™ by Microsoft Corporation™ may be used to run the architect room. A new tree may be created in the architect room 702. The architect room lets a project architect define schema nodes of a tree, but not the node instances. The instance nodes may be created in the Type Room by “cloning”, which will be discussed later. The schema nodes define the structure of the tree.

To further specify the preferred embodiment, the six types of attributes in the content architecture are defined as:

1. Text attribute—simple text.

2. Gif attribute—simple picture, either .gif or jpg file. Gif attributes have two parts, the file name and image caption, if any.

3. List attribute—one dimensional array. Each element is called a list option or item. Each option consists of a (name, value) pair. It is possible that the program code only uses one of the pair, in which case, the designer can make name=value. The number of options can increase indefinitely in run time. Default name and value pairs may be given during node creation in the architect room.

4. Table attribute—two dimensional array. Each cell in table can contain other attributes, including another table. Table attribute columns are defined during creation. Table rows can increase indefinitely.

5. Anchor attribute—Used in hyper links the anchor attribute may be used to provide a compound attribute with the following parts:

a. nodePath—nodepath of a contextID node.

b. anchorNode—final node of a contextID node.

c. anchorText—text displayed in the hyperlink, default to the anchorNode.

d. jspFilename—the j sp file to be served.

e. hostname—hostname of the server, a.k.a. domain name, default to same server the j sp file is served from.

f. anchorimage—if an image is displayed for this anchor.

g. otherAttribute—any other attributes to be included in the anchor tag, e.g. width=122.

6. Bag attribute—attribute who type cannot be determined until run time. A bag attribute is typically a combination of many attributes of type 1 to 5. Used most commonly for personalization, where very different content types need to be displayed for different viewers.

A service chain may also be created and defined in the architect room 702 (step 608). The service chain is a workflow like process model, which captures both the call signature and call sequence (protocol) needed to complete a complex business transaction. The service chain can be viewed as basically a collection of URL calls. The call signatures are explicit in the chain definitions.

In addition, there are proprietary protocols within the framework that the service chain can access via URLs. Proprietary protocols used by a preferred embodiment of the invention include: content architect read and write, rule engine, other service chains, search engine, scrape (web scraping off a html page), and post (do a http post to a web site). More specific examples of these protocols will be provided in the “Example” section.

The Service chain, combined with a rule engine, allows for the construction of very complex business transactions with parallel execution path, parameter aggregation, exception handling, and workflow navigation. This sophistication allows the service chain to capture complex real-world business transactions that are multi- stage, multi-tasking, capable of content based routing, and involving external business applications and trading partners. The service chain can be designed top down (business view first, before drill down to machine and document calls), or bottom up (system calls first, then aggregate low level steps into business tasks).

When coupled with the content architect, the service chain is a very effective implementation of an application logic engine. As an application executes, the service chain reads from a source tree and writes out a destination tree, creating alternative views of content as specified by the application requirements. This tree-to-tree content transfer is defined as structure transformation. Not only are individual data elements transferred and translated, the overall content structure can be altered in the process, such that hierarchy of the tree structure can be reversed (parents become children and vice versa). It is because of this capability that the service chain also makes a good XML transformer.

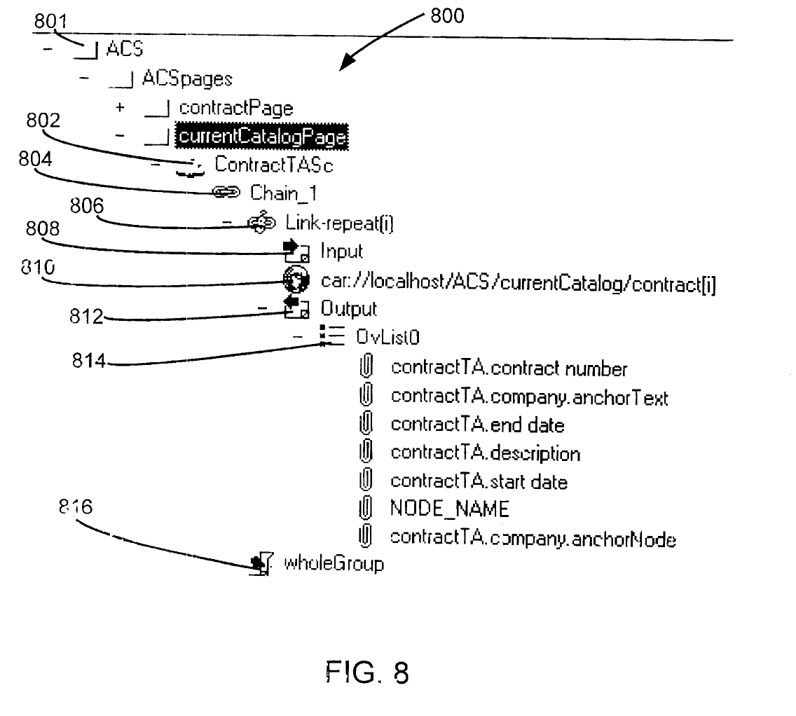

FIG. 8 is an illustration of a service chain 800 used in the preferred embodiment of the invention. The service chain 800 is in the form of a hierarchical tree and is created within a hierarchical tree where the root node 801 bears a project name of ACS. The elements in a service chain are defined below as:

1. Service 802—a complete service with a specific URL. Can be called anywhere within the inventive framework to perform a task. A service can contain multiple chains.

2. Chain 804—a unit of process flow. New chains are needed whenever there is a split and merge configuration. A chain consists of a sequence of links.

3. Link 806—a unit of function call, with one set of input variables, one URL call, and one set of output variables returned by the URL call.

4. Input 808—a set of single parameters. A parameter can be a single string, or a pointer to a content architect structure, which may represent, for example, an XML document. Each parameter is a (name, value) pair. An input parameter is referred to by its name or index any where within the same service. Parameter value is either filled in at run time, or its default value (set at design time) is used. A service chain link will halt and wait if one of its input parameters does not have its value fulfilled.

5. URL 810—uses text and symbol convention consistent with the World Wide Web URL (Uniform Resource Locator). However, an URL in the preferred embodiment can make calls to many proprietary protocols within the inventive frame work, but not available from external servers.

6. Output 812—a set of either single parameters (ov) or parameter lists 814 (ovlist). Each ov or ovlist item is a (name, value) pair. The parameter name must match the attribute name of the destination tree node, which is connected by binding. The parameter value can be made up of:

a. Constant string;

b. Concatenation operator “+”;

c. Output parameters of the URL (returned values from the URL);

d. Keywords such as NODE_NAME, parent.NODE_NAME;

e. Any variables on the same service chain;

f. URL's making calls to proprietary protocols.

7. Exit 816—exit contains two parameters, a DOM (Document Object Model) and method. The DOM values depend on the exit method. DOM is filled in automatically during web scraping. During manual service chain creation, the user can enter two methods, which are split and decide. If decide is the method of exit, an exit code must be filled in the DOM slot to pick out which chain will be followed. In case there is no routing switch, the exit simply continues into the next link, then the user does not enter anything for either variable.

The link may be a single or repeating link. Repeating links iterate from the link node to the exit node, making the URL call repeatedly with incrementing index [i], until the exit condition is satisfied. In the preferred embodiment, the valid exit conditions include: allRows, iteration through a table, and wholeGroup, iteration through a peer group of content architect nodes that are cloned from the same schema node.

A chain is used whenever the flow of execution changes. For example, in a split flow, one chain becomes two parallel chains. The split may actually be a decision branch, in which case, only one of the parallel chains will continue the flow. In a merge situation, multiple chains become one chain either via a true merge. Again, depending on whether the multiple chains were in a split or decision, the merge node will either wait for all preceding chain to hand off, or wait for the first one, respectively.

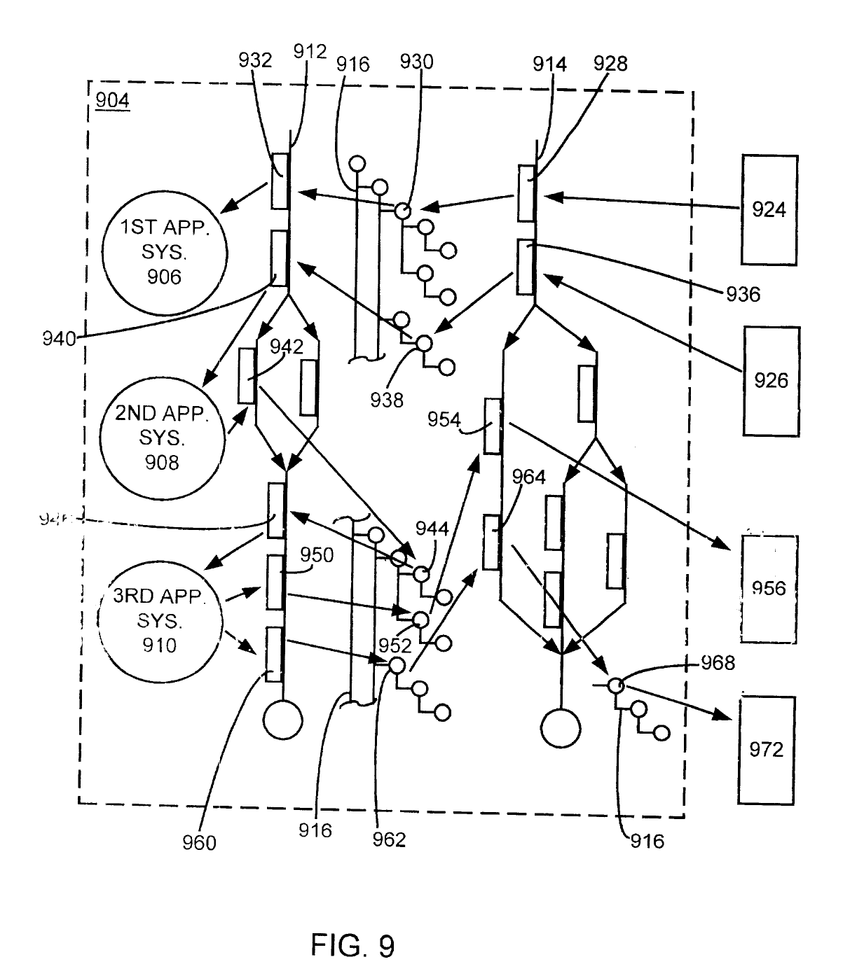

The service chain and content architect may then be bound (object binding) (step 612). FIG. 9 is a schematic illustration of how service chains and a content architect may be bound in a preferred embodiment of the invention. In FIG. 9, an enterprise system 904, comprises a first packaged application 906, a second packaged application 908, and a third packaged application 910. A first chain 912 in the service chain and a second chain 914 in the service chain are schematically illustrated. Trees 916 of the content architect are also schematically illustrated. Information for the enterprise system 904 may be provided by an external partner's enterprise system 924 or from an external web page 926.

During the binding of the content architecture to the service chain (step 612), the external partner's enterprise system 924 may be connected to a first link 928 of the second chain 914, which may be connected to a node 930 of the trees 916 of the content architect. The first link 928 is a function call that receives input from the external partner's enterprise system 924 and provides output to the node 930. A first link 932 of the first chain 912 may be connected to the node 930 and the first packaged application system 906. The first link 932 of the first chain 912 is a function call that receives input from the node 930 and provides output to the first packaged application system 906.

The external web page 926 may be connected to a second link 936 of the second chain 914, which may be connected to a node 938 of the trees 916 of the content architect. The second link 938 of the second chain 914 is a function call that receives input from the external web page 926 and provides output to the node 938. A second link 940 of the first chain 912 may be connected to, the node 938 and the second packaged application system 908. The second link 940 of the first chain 912 is a function call that receives input from the node 938 and provides output to the second packaged application system 908.

The second packaged application 908 may be connected to a third link 942 of the first chain 912, which may be connected to a node 944 of the trees 916 of the content architect. The first chain 912 is divided into two sub-chains just before the third link 942, as shown. The third link 942 of the first chain 912 is a function call that receives input from the second packaged application 908 and provides output to the node 944. A fourth link 946 of the first chain 912 may be connected to the node 944 and the third packaged application 910. The fourth link 946 of the first chain 912 is a function call that receives input from the node 944 and provides output to the third packaged application system 910. The fourth link 946 in the example shown in FIG. 9 is located after the point where two sub-chains of the first chain 912 merge into a single chain.

The third packaged application 910 may be connected to a fifth link 950 of the first chain 912, which may be connected to a node 952 of the trees 916 of the content architect. The fifth link 950 of the first chain 912 is a function call that receives input from the third packaged application 910 and provides output to the node 952. A third link 954 of the second chain 914 may be connected to the node 952 and an external partner's enterprise system 956. The second chain 914 is divided into two sub-chains just before the third link 954, as shown. The third link 954 of the second chain 914 is a function call that receives input from the node 952 and provides output to the external partner's enterprise system 956.

The third packaged application 910 may be connected to a sixth link 960 of the first chain 912, which may be connected to a node 962 of the trees 916 of the content architect. The sixth link 960 of the first chain 912 is a function call that receives input from the third packaged application 910 and provides output to the node 962. A fourth link 964 of the second chain 914 may be connected to the node 962 and another node 968 of the trees 916. The fourth link 964 of the second chain 914 is a function call that receives input from the node 962 and provides output to the node 968. The output node 968 provides web site content. Although the output node 968 is part of a tree that forms the content architect, since that part of the tree is bound to a web page, that part of the tree may also be called a page tree. A web page 972 may be connected to the node 968. Because the content architect tree uses object types that are completely compatible with web specification, this embodiment is able to automate the delivering of content from the content architect tree to an HTML page without further glue logic.

In the preferred embodiment, the first chain 912 forms a backend interface, which provides communication between the content architect trees 916 and the backend of the enterprise system 904. The second chain 914 forms a public interface, which provides communication between the content architect trees 916 and the outside world. Preferably, information is stored in the content architect in the form of XML documents, allowing XML to be a unifying language to which information is translated to and from. The first chain 912 and second chain 914 form a frame work called a Double Helix, since links in the parallel first chain 912 and second chain 914 are intertwined in their interactions.

The examples of receiving of information from a partner's enterprise system and providing information to a partner's enterprise system illustrate how the invention facilitates business to business (B2B) communications between different company enterprise systems. The example of receiving information from a web site, is an example of how the invention facilitates obtaining information from the world wide web over the Internet or an intranet. The example of providing information to a web site is an example of how the invention facilitates providing information to a web site. By automatically providing information to a web site, the invention allows a dynamic generation of web pages, by automatically providing data to the web site. This provides information through a web site, which is automatically updated and where the provided data may be dynamically generated content in response to a user's special request.

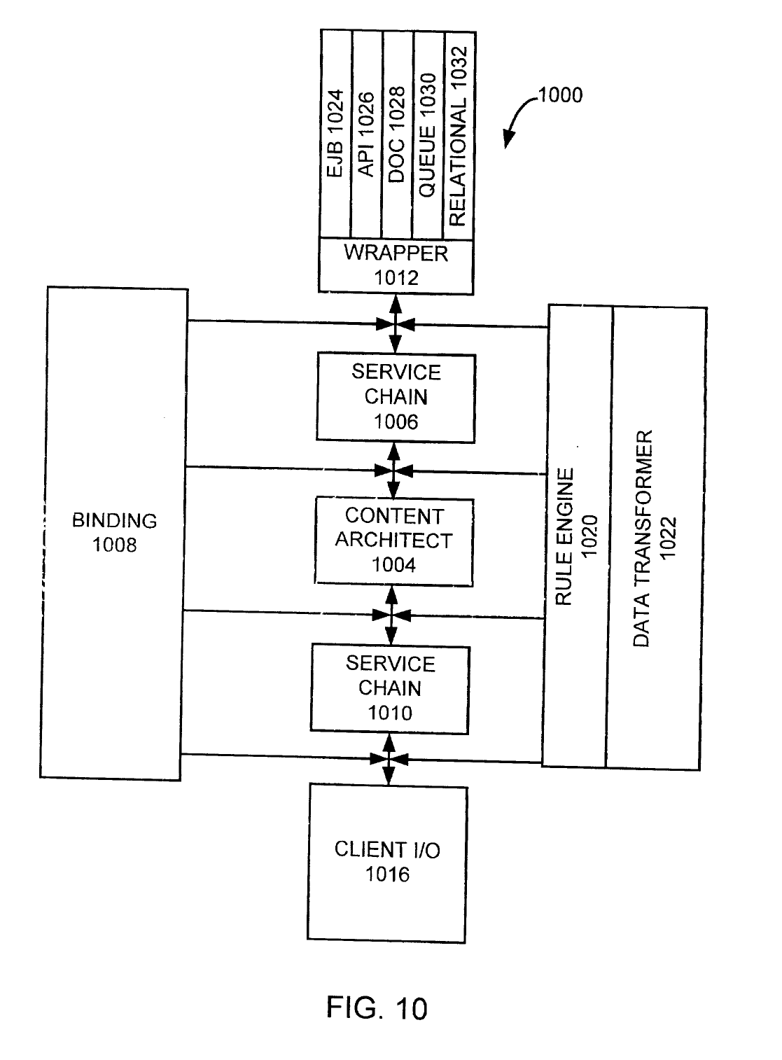

In a preferred embodiment of the invention, the connections that provide any read function to a link are performed using URL calls. The connections that provide a write function from the links of the service chain to the first packaged application 906, second packaged application 908, third packaged application 910, or an external partner's enterprise systems 924, 956 are performed using URL puts. The use of a URL call and put allows communication (connection) with World Wide Web enabled systems, since such systems use URL calls and puts. For a systems that is not World Wide Web enabled, a wrapper is provided, which translates the URL calls and puts into commands that are understandable by that system. Such wrappers are illustrated in FIGS. 5 and 10 and will be discussed in more detail below.

For connections between links of the service chain and nodes, where the node is the output of the link and connections between a node and a web page without a link is in general called content binding. More specifically, connections between links of the service chain and nodes, where the node is the output of the link is called object binding. Connections between a node and a web page without a link is called page binding. For example, the connection between the first link 928 of the second service chain 914 and the node 930 and the connection between the node 968 and the web page in general may be called content binding. More specifically, the connection between the first link 928 of the second service chain 914 and the node 930 is object binding. The connection between the node 968 and the web page 972 is page binding. Object binding and page binding will be described in more detail below.

FIG. 10 is a schematic view of an enterprise system 1000 with a content wrapper. The enterprise system 1000 comprises a content architect 1004, a first service chain 1006, a binding 1008, and a second service chain 1010 as described before. In this example, a client (input/output) 1016 may also be part of the enterprise system 1000. A content wrapper 1012 is connected between the first service chain 1006 and systems that provide information to the service chain 1006. The content wrapper may be used for connecting to a wide range of backend systems and components, such as an enterprise JavaBean™ (EJB) 1024 software component (or other software components), an application protocol interface/remote procedure call (API/RPC) system 1026, documents 1028 (such as XML/HTML documents), message queues (such as IBM MQ Series) 1030, and relational databases 1032. The content wrapper 1012 reduces the call interfaces. In the preferred embodiment, the content wrapper 1012 reduces the call interfaces to an URL format and encapsulates each entire call signature as well as a domain name needed to find a distributed computing host. For example, for an enterprise JavaBean EJB software component, the content wrapper 1012 may place a constrain on the output type to limit the set of possible return objects.

In the preferred embodiment, the content wrapper 1012 allows access to the back end systems using an URL and input/output parameter designations. As an example, a call to SAP RFC may be

SAP://domainName/rfc_callname?param1= . . . &param2= . . .

In case of Oracle relational databases, the URL takes the form of

ORA://serviceName/query?uID=uID&passwd=passwd&queryString=“ . . . ”.

The document interface derives its URL from standard HTTP like syntax with the addition of a DOM string for accessing elements within the document.

DOC://domainName/path/doc?DOM=“ . . . ”.

In other embodiments, the URL may be migrated to the XPointer standard once the XPointer standard becomes final. In case of html documents, the content wrapper allows the user to directly scrape elements off the page, and the protocol used in this case is simply “scrape:”.

For an EJB software component the content wrapper interfaces with session beans to extract information needed for web publishing. In this case, the URL would take the form of

EJB://domainName/bean/method?param1= . . . &param2= . . .

The content wrapper automatically accepts a large set of method return types, such as String, StringBuffer, Integer, int, char, Date, Image, Applet, Collection, Enumerations, Array, Vector, and List.

A data transformer 1022 is provided to facilitate the translation of information to and from XML. A rule engine 1020 is provided for low level rule construction, which enables dynamic content generation, personalization, process flow navigation, exception handling, and data transformation. The rule engine 1020 resolves data incompatibilities whenever direct binding between elements fails. Preferably, the rule engine 1020 allows seamless insertion of rules, and a uniform user interface. There is no paradigm switching when applying rules in the binding process.

The rule engine 1020 may be involved in every stage of content binding for data transformation, for personalization of content from the content architect, e.g. different prices for different class of users, exception handling, e.g. a wrong input field in a submitted form can be caught by the rule engine, and a warning response sent, within the service chain, input and output parameter binding may be complex and requires uses of rules, derivation of next stage URL in a service chain may involve rules to allow for dynamic process flow.

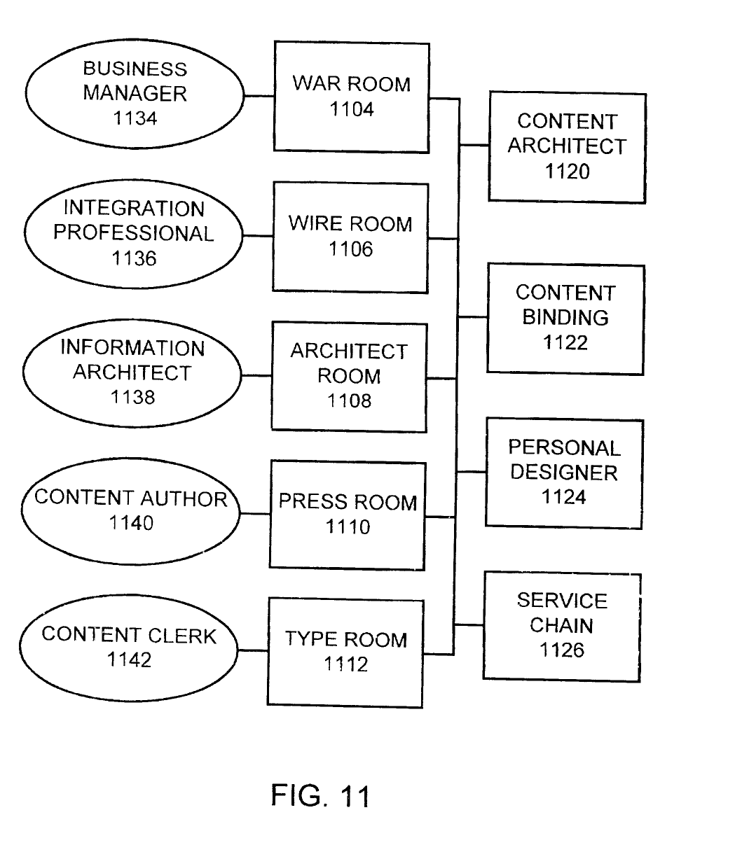

FIG. 11 is a schematic illustration of various user interfaces provided by a preferred embodiment of the invention. Graphical user interfaces called a war room 1104, a wire room 1106, an architect room 1108, a press room 1110, and a type room 1112 are provided by a preferred embodiment of the invention.

The architect room 1108 may have a graphical user interface as shown in FIG. 7 and as describe above regarding FIG. 7. The information architect would be the user of the architect room 1108. The architect room 1108 may be used to create and modify tree schemas for both the content architect 1120 and the service chain 1126. A tree schema is simply a database design. The information architect's function is similar to the database administrator's task of designing relational table schemas. Unlike conventional database management systems, however, the tree schema and actual database objects are created separately. This makes it possible to re-use tree schemas anywhere in the project and propagate project-wide changes without having to change each instance of a node. The nodes are instantiated by “cloning” in the Type Room, as will be described below.

Information architects are ideally people who understand the business requirements and know how to translate them into a hierarchical structure.

The architect room has seven tab panels, as shown in FIG. 7, for Architect 708, Scrape 710, Service 712, Resources 714, Events 716, Forms 718, and CheckOut 720. The most important three are Architect, Service, and Event. The CheckOut tab 720 shows checkout status of trees and service chains.

The Publish button 722 commits changes made to the database. This icon should be clicked to make changes permanent. Unpublished changes will be lost after shutting down. The Redisplay button 724 may be normally selected after drilling down on a particular node to get back to the first level tree listing. The redisplay button 724 causes the display to show the top node along with first level trees in the tree schema. The refresh button 726 causes the preferred embodiment of the invention to read from the database and show all changes made on the tree schema. The bind to button 728 may be used to bind service chains in the Service tab to nodes in the Architect tab. An checkout button 740 may turn into an uncheckout button to reverse the checkout process. A new button 732 may be provided to add new elements to the tree schema depending on the element selected in the tree schema. A change button 734 may be provided to change an attribute of a selected item from one type to another. A delete button 736 may be provided to delete a selected item. A rename button 738 may be provided to rename an item. In other embodiments, these buttons may be provided as drop down menu items or using other GUI selection tools.

FIG. 12 is an illustration of another architect room interface 1206, where only four tab panels are shown. As shown, the “directory” node 1208 is the first level child node under the project node 1206. Nodes in this level are known as category nodes. They serve as singletons in the project and are not to be cloned in the type room. All nodes below category nodes, however must be cloned in the type room before they are real nodes. Cloned nodes are called instance nodes; the node they are cloned from are called schema nodes. As shown in FIG. 12, the node “member” 1210 has seven child nodes 1212, which are attributes of the “member” node 1210.

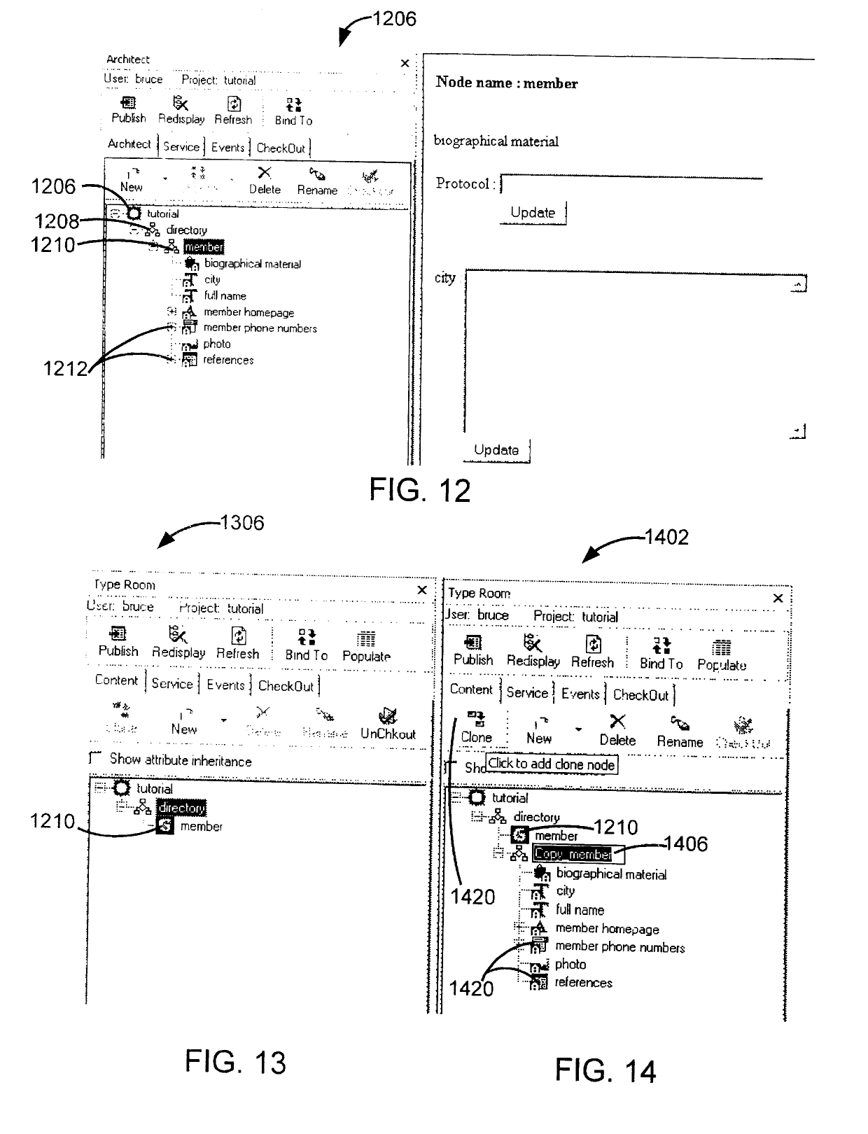

FIG. 13 is a first view of a window for a type room interface 1306. Once the tree schema is created, it can be populated in the type room 1112. A content clerk 1142, who uses the type room 1112, creates instance nodes by first selecting the black G 1210 or group node called “member, as shown in FIG. 13. The node “member” is the schema node in that it is a node that is used to define the database structure, such as attributes defined by the child nodes 1212. When the node “member” 1210 is selected a clone button 1420 becomes selectable, as shown in FIG. 14, which is a second view of a window for a type room interface 1402. When selected the “member” node 1210 becomes cloned to generate the “Copy member” node 1406 with clones 1408 of all attributes (child nodes 1212) of the “member” node 1210. The “Copy_member” node 1406 is an instance node of the “member” node 1210, which is a schema node. A group node, such as the member node 1210, is representative of the schema node except it shows up under each instance of parent node (a schema node only shows up under another schema node in the architect room 1108).

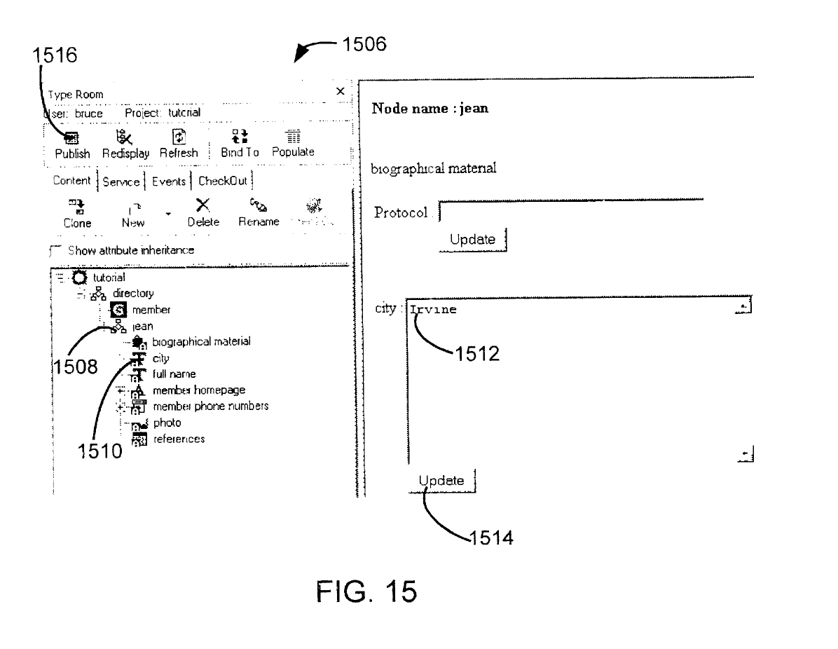

After cloning, the content clerk 1142 may enter a new name for the cloned node, and values for each of its attributes. FIG. 15 is a third view of a window for a type room 1506 with a form to allow the entry of an attribute. In FIG. 15, the cloned “Copy_member” node has been named “jean” 1508. The node or attribute named “city” 1510 has been defined as “Irvine” 1512. The content clerk may then select the update button 1514 to cause the attribute “city” to be updated. The user can enter as many instance nodes as desired. After the nodes are created, and attribute values entered, the publish button 1516 is selected to send all new data to a server for storage.

The service chains 1126 may be equally created in the architect room 1108 or the type room 1112. While the service chains 1126 themselves are the same in either room, the binding mechanism produces different results for each room. The architecture room 1108 produces pull mode binding (for populating dynamic trees and page trees), while type room 1112 produces push mode binding (for populating persistent trees).

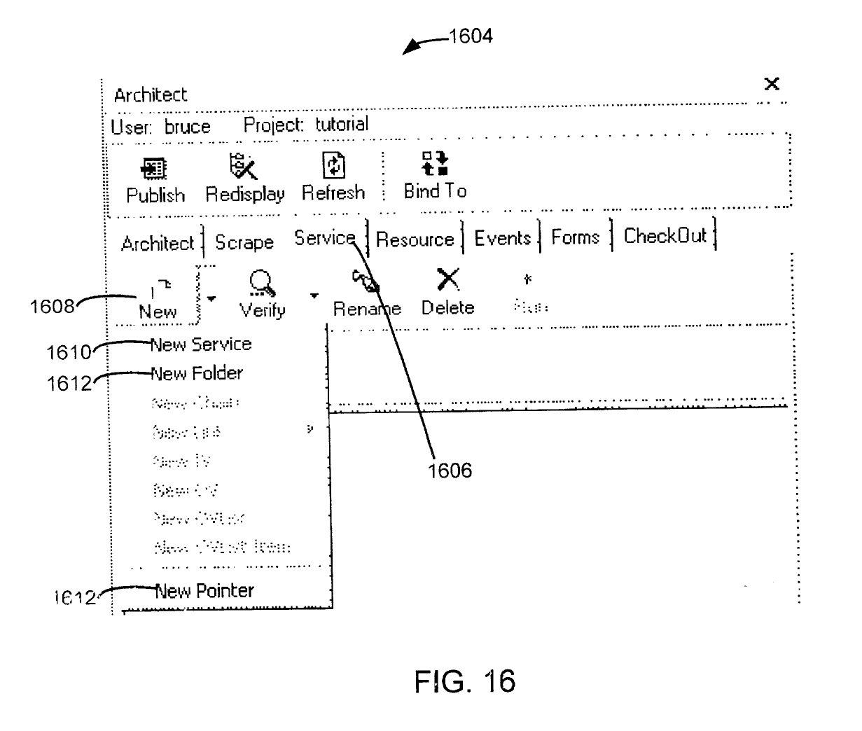

FIG. 16 is a view of an architect room window 1604, which is set to create a new service. The “Service” tab 1606 has been selected so that the “New” button 1608 is revealed. The selection of this “New” button 1608 provides a pull down menu, which offers a selection for “New Service” 1610, “New Folder” 1612, and “New Pointer” 1616. The selection of “New Service” 1610 allows the creation of a new service chain. Service chains may be created under service folders, which helps the user organize all the service chains in one project. The user can add new folders and new services (service chains) as needed. It is also possible to have multiple pointers pointing to one service using the new pointer button menu.

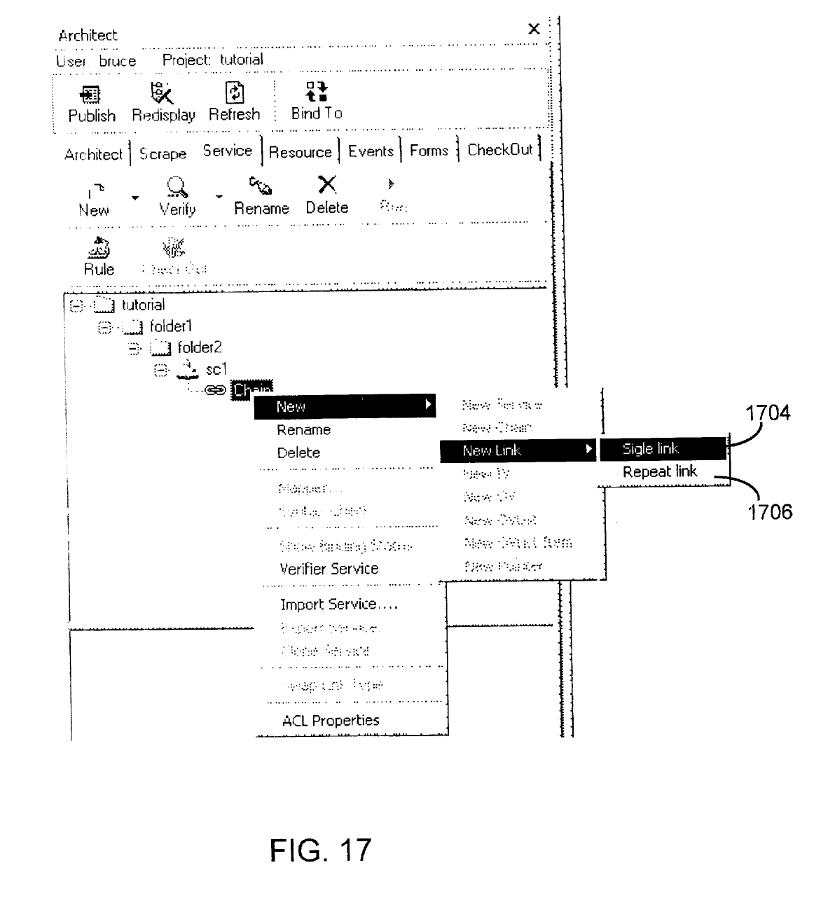

Once a new service is added, the user can add all the necessary nodes onto it to create a complete service chain. These nodes as discussed above are chain, link, URL, input, iv, output, ov, ovlist, ovlist item, and exit. Since the user interface provides these nodes in a fixed pattern, it is not possible to add the wrong type of node to another node. After a new service is created, the first chain is automatically added. As illustrated in FIG. 17, the user may choose for a new link node in a chain either a single link menu selection 1704 or a repeating link menu selection 1706. Single and repeating links are described above regarding FIG. 8. In the preferred embodiment of the invention an “i” is added to an icon for a link to indicate the link is a repeating link. The new link node may automatically be provided children nodes, which in the preferred embodiment are input node, URL node, output node, and exit node, which are discussed above regarding FIG. 8. In the preferred embodiment, the GUI allows a user the options of typing in information, such as the URL, or browsing trees including content trees, service chains, rule engines, and other variables which may be selected for the information, such as the URL. Browsing may also be available for providing an input source or output destination.

The type room may also be used for object binding. In the preferred embodiment, the type of object binding that is performed in the type room is push mode binding. As discussed above, object binding is between a link in the service chain and a destination node. Push mode binding directs output of a service chain to a destination tree (usually a persistent tree). Data transfer occurs every time the service chain executes. The initiating party of the update is the service chain, not the receiving tree. The steps of this type of binding are:

1. Expand the source in the service tab panel, down to the level where the output parameter (ovl or ovlist) is visible. Then select the “check out” selection to select this service. The “check out” tab may be seen in FIG. 15, which illustrates the “Type Room” GUI.

2. Expand the destination tree in the content tab panel, down to the level where the parent of the receiving node is expanded and all Group nodes under it are visible. A group node represents the schema from which all nodes in the group are cloned. Then select the “check out” to check out the parent node.

3. Go back to the source service chain. Select the ov or ovlist item to be bound.

4. Click the boundTo button.

5. Go the content tab panel, click on the Group node representing the receiving nodes.

6. If the designer wants to save this binding, hit publish. In the alternative the designer may instead want to perform a one time data transfer and loose the binding afterwards.

Notice that in this preferred embodiment the destination node has to be a Group node, not an Instance node cloned from the Group node. This is because when the binding is executed, a new node is generated by cloning the Group node. Part of what the Binding Manager has to deliver is the name of the instance node to be created by this binding. If the node name already exists in the destination tree group, then the content from this binding will simply overwrite the current attribute values. Push mode binding can execute on either the client (Type Room) or server. Since the preferred embodiment uses pointing and clicking to facilitate binding, the binding process is much easier.

A general process flow involves reading from a content source (a tree or any other source) using the URL, performing transformation on the fly, and passing the result to a destination tree via binding. The Binding Manager 1008 will carry out the binding specified by the user whenever a service chain link is executed.

Each of the ovlist item is a name-value pair. The value part of the ovlist item consists of keywords, concatenation operator, sc variables, and URL calls. This essentially makes up a mapper, which derives the destination value from many possible sources. Because this mapper transforms not only single elements, but can alter the hierarchy of the information structure, we call this capability structure transformation. it is much more powerful than data transformation, and servers as a very efficient XML translator is.

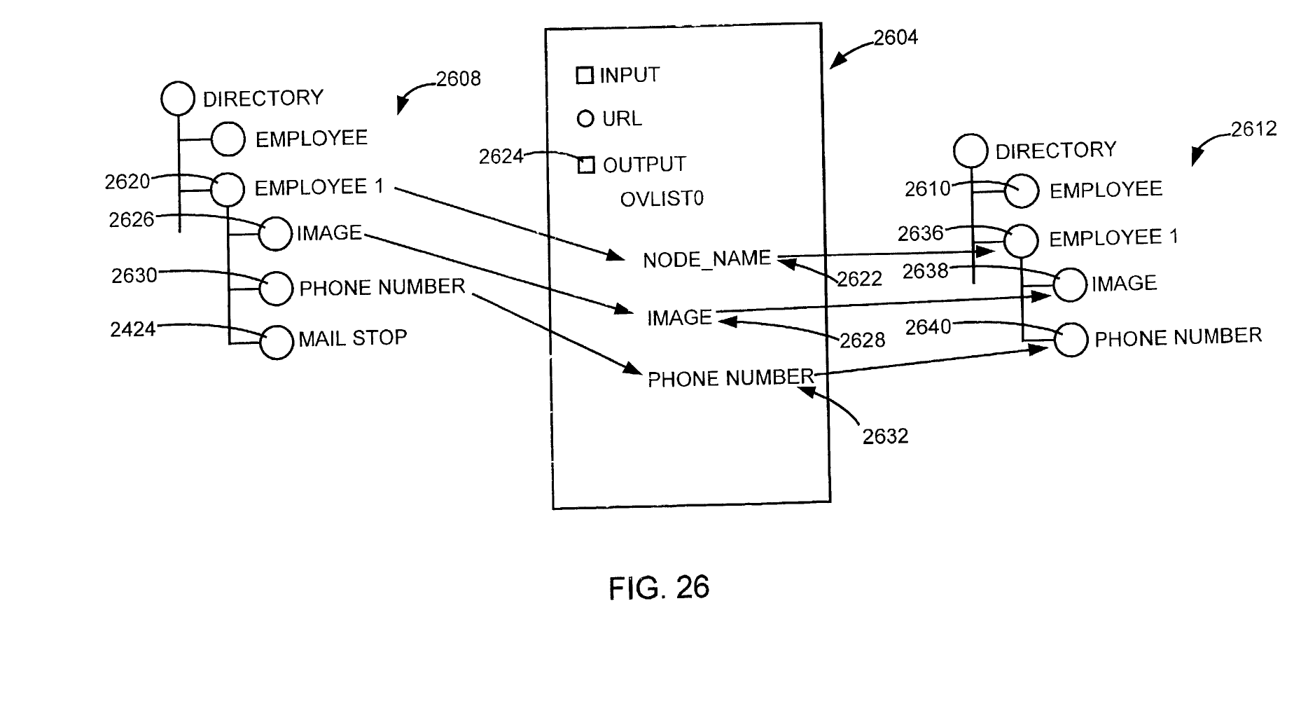

FIG. 26 is a schematic view of a link 2604, which reads from a first tree structure 2608 and is bound to a schema or group node 2610 of the content architect 2612. The link 2604 may designate the first tree structure as input. The first tree structure may be part of the content architect or may be a tree structure in a wrapper, which forms data in a packaged application into a tree structure in a form similar to the content architect. A URL read is made to the first tree structure to read data from the first tree structure 2608 to the link. As a result, the “employee 1” information 2620 is read into the “Node_Name” 2622 of the Ovlist0 2624. The “image” information 2626 is read into the “image” 2628 of the Ovlist0 2624. The “phone number” information 2630 is read to the “phone number” 2632 of the Ovlist0 2624. Since the link 2604 is bound to the schema node 2610, the link 2604 writes contents in the Ovlist0 2624 into an instance of the schema node 2610. The “Node Name information 2622 is used as the name of the instance node 2636 of the schema node 2610. The “image” information 2628 of the Ovlist0 is written into the image attribute 2638. The “phone number” information 2632 is written into the phone number attribute 2640. The link 2604 provides expression during the write process. Expression allows some transformation of the data as it is written. In this example, as the “Node_Name” is written to be the name of the instance node the information is transformed from lower case lettering to all capitalization. Another type of expression is concatenation. Therefore a bound link in general performs a URL read from a source and stores data in an output, usually an output list. The link then transfers information from the output to a node to which the link is bound. Such binding causes the link to transfer the information into a node name and attributes of the node. Thus a collection of attributes are transferred from an input tree to an output tree through the service link.

The architect room may also be used for object binding. In the preferred embodiment, the type of object binding that is performed in the architect room is pull mode binding. As discussed above, object binding is between a link in the service chain and a destination node. Pull mode binding is a more powerful mechanism used for most of application creation. In this case, the destination tree (a dynamic tree) initiates the action, triggering the service chain responsible for populating it. This trigger occurs when a dynamic node's parent is expanded (either by user clicking the plus sign on the client, or by a tree read operation on the server). The procedure for creating pull mode binding is identical to push mode binding, except it is done in the architect room.

The press room 1110 may be used by content authors 1140, such as web masters, to deliver dynamic content from content architect 1120 trees to web pages. The content author performs page binding by joining between attributes of a tree node to an HTML element on the web page. The tree node feeding a web page is called the content node, and its node path is specified by the contextID parameter in the URL. Preferably, the content node is part of a tree in the content architect. In the preferred embodiment, this binding of HTML elements is done using a page binding technique, which eliminates detailed jsp coding in the page binding process. HTML elements such as <p>, <table>, <li>, <span>, <div>, <img>, <a> are selected out of a static html page and bound to a matching attribute on a tree in the content architect 1120. During the page binding <p>, <span>, and <div> objects are matched with nodes with a text attribute, <li>objects are matched with nodes with a list attribute, <table> objects are matched with nodes with a table attribute, <img> objects are matched with nodes with an image attribute, and <a> objects are matched with nodes with an anchor attribute. Some of these elements that are bound to a page may be non-visual elements.

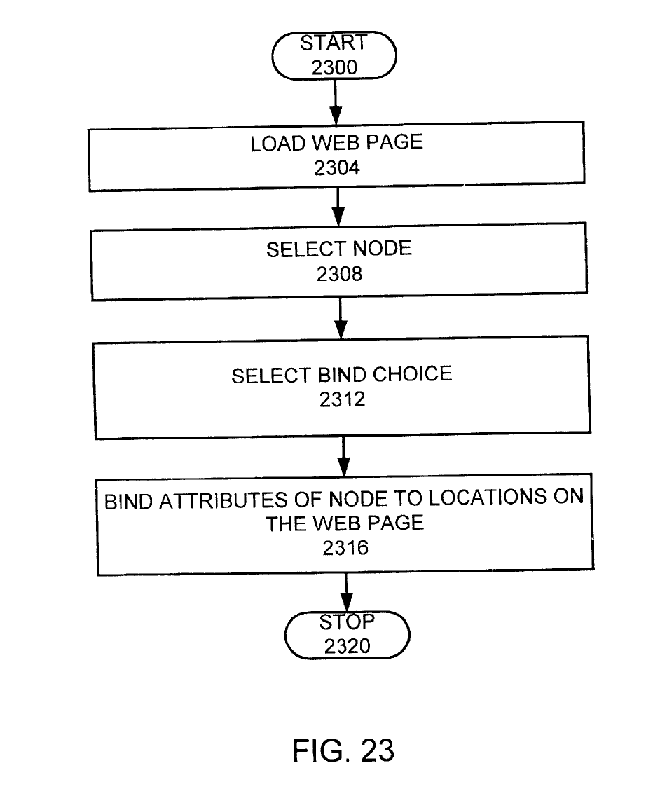

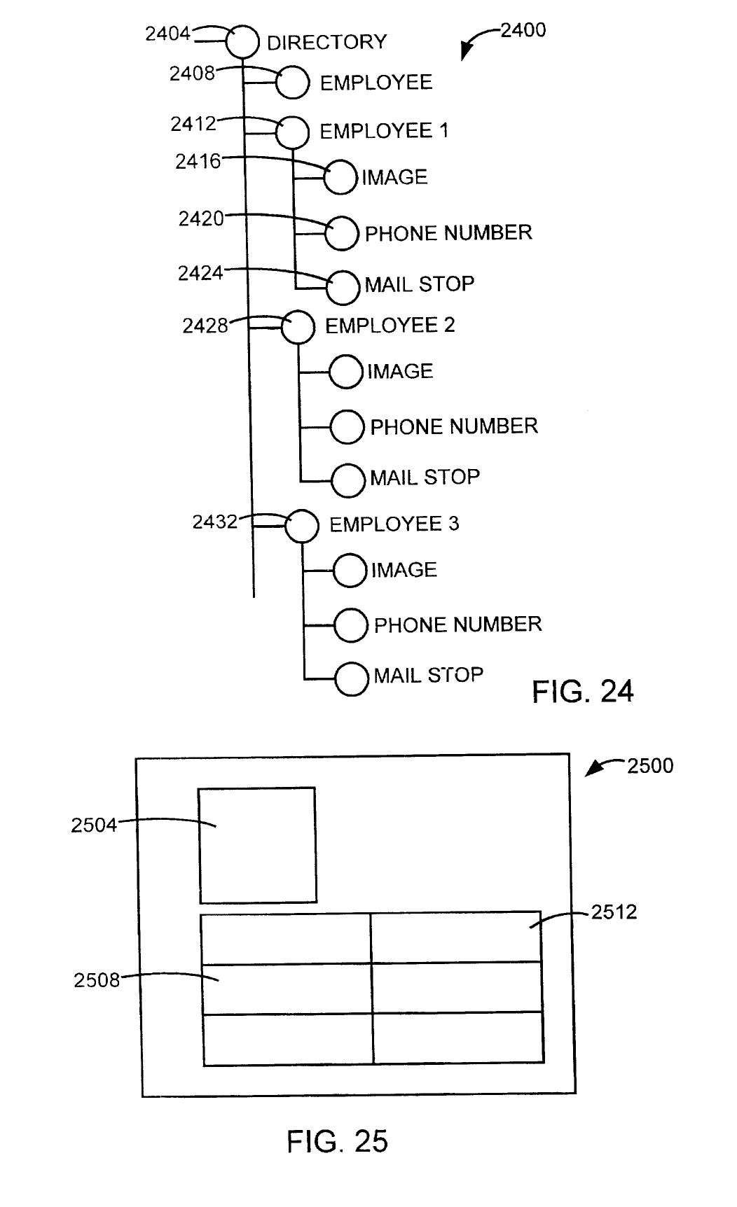

To provide a schematic overview of the web binding process that may occur in the press room, FIG. 23 is a high level flow chart of the page binding process in a preferred embodiment of the invention. FIG. 24 is a schematic illustration of part of a content architect tree 2400. FIG. 25 is a schematic illustration of a web page 2500 that is to be page bound. First a web page is loaded (step 2304). The web page 2500 is loaded by viewing the web page using a web browser. Next a node is selected (step 2308). The node may be selected by simply pointing and clicking on the node. In this example, the part of the content architect tree 2400 is a directory tree 2404. A schema node “employee” 2408 defines the attributes of employee nodes. The “employee 1” node 2412 is a first instance of the employee node 2408. In this example, the “employee 1” node 2412 has the attributes “image”, 2416 “phone number” 2420, and “mail stop” 2424. The schema node “employee” node 2408 has the same attributes, but they are not shown to simplify the illustration. Other instances of the “employee” node 2408, such as the “employee 2” node 2428 and “employee 3” node 2432 are peers of the “employee 1” node 2412. In this example, the “employee 1” node is selected by pointing on the “employee 1” node 2412 and clicking a mouse button. A bind choice is then selected (step 2312). This may be done by selecting a button, as described below or a menu selection on a pull down menu or by other selection means. In other embodiments, this may be done implicitly by binding the attributes discussed below. Next the attributes of the selected node (i.e. “employee 1” node 2412) are bound to locations on the web page 2400 being viewed by the web browser. In the preferred embodiment this is done by first selecting a region in the web page. For example a picture region 2504 may be selected. The preferred embodiment allows the defining and selection of a region of a web page using a web browser to view the web page and select the region. A bind choice, such as a bind button, is then selected. Then the image node 2412 is selected, by pointing and clicking. Next a mail stop region 2508 of the web page 2500 may be selected. The bind button may the be selected, and then the “mail stop” node 2424 may be selected. Then a “phone number” region 2412 of the web page 2500 may be selected. The bind button is then selected and then the “phone number” node 2420 is then selected. As a result the information from the attributes may be displayed in the selected regions of the web page 2500. In addition, all of the peers of the bound node are also bound to the web page. This means that the “employee 2” node 2428 is automatically bound to the to the web page 2500. Therefore, the web page 2500 may be used to view the attributes of employee 2. Similarly, the “employee 3” node 2432 is also bound to the web page 2500.

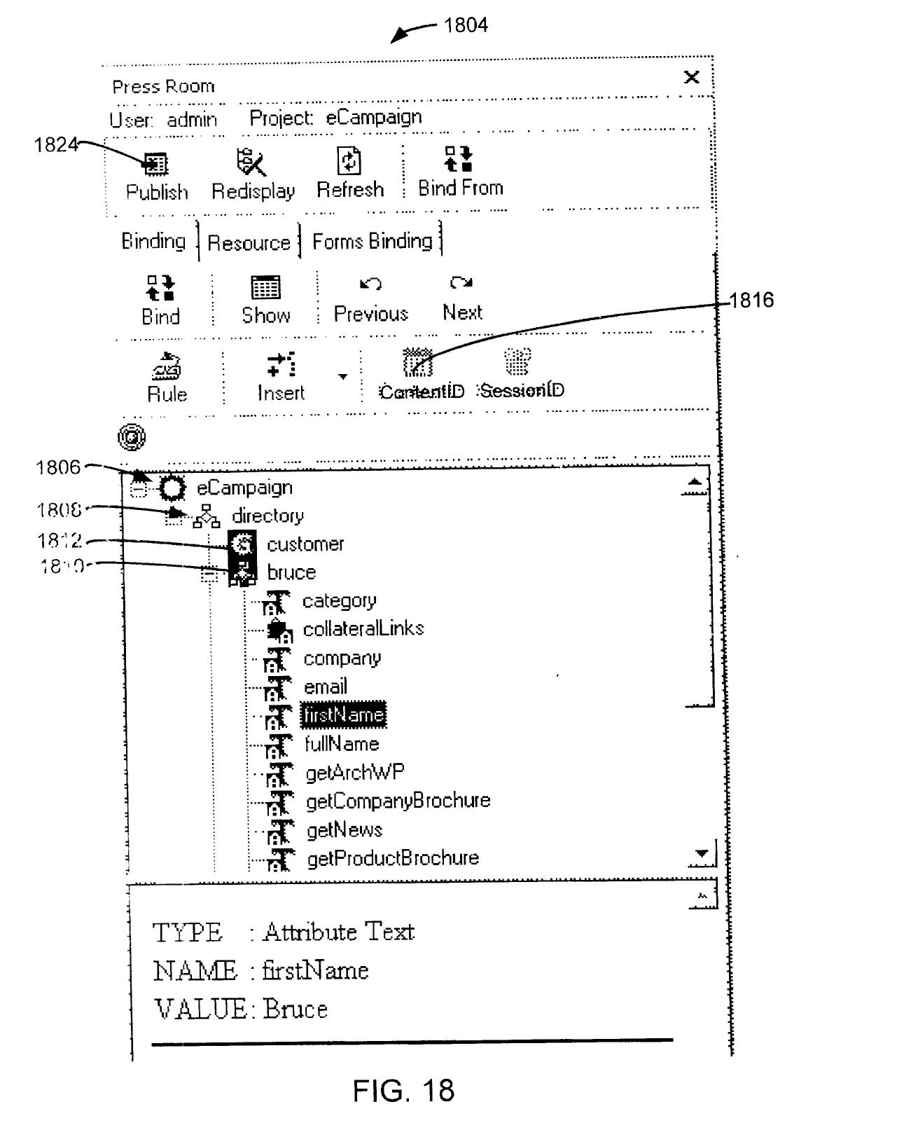

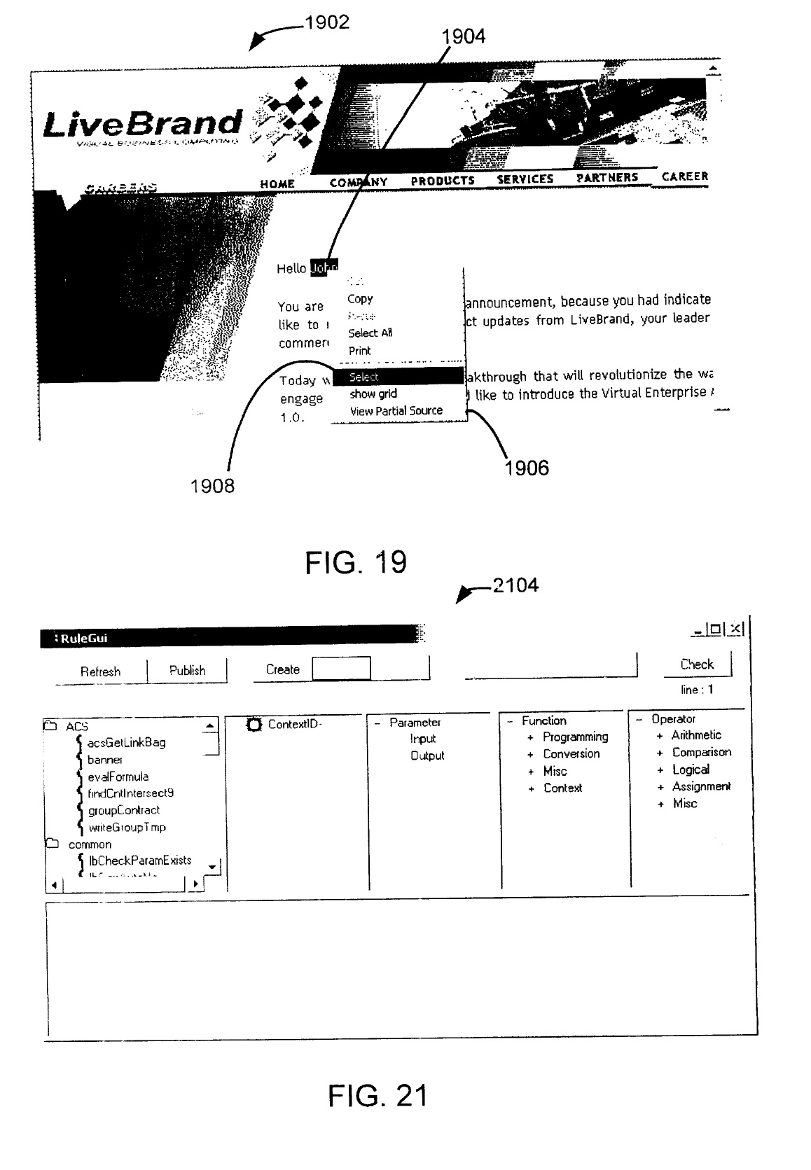

FIG. 18 is an illustration of a press room GUI 1804 provided by a preferred embodiment of the invention, providing a more specific example of page binding. FIG. 19 is an illustration of a web page that is loaded on a web browser (step 2304). The press room GUI 1804 in FIG. 18 displays an “eCampaign” tree 1806 of the content architect. An expanded “directory” tree 1808, which is a subtree of the “eCampaign” tree 1806, has a “bruce” branch with a “bruce” node 1810 being the root of the branch. The content author 1140 is able to see all of the attributes of the “bruce” node 1810, which is an instance of the “customer” node 1812. The content author 1140 may start the page binding process by selecting the context node, such as the “bruce” node 1810 (step 2308) and then selecting the ContentID button 1816 (step 2312). The selection of the ContentID button 1816 may cause the “bruce” node 1810 to be highlighted in some fashion. The ContentID button 1810 initiates a ContentID mechanism, which is used to make sure that a bound html element will only accept attribute values from the context node or one of its peers in the same group. The content author 1140 may then select an element from a web page to which the “bruce” node 1810 is to be bound.

The word “John” 1904 is selected, by highlighting the word “John” 1904, and the choosing from a pull down menu 1906 the word “Select” 1908. This preferred embodiment provides a unique personal designer, which is able to select a region on the web page, using a web browser. This personal designer may be used for interacting with a HTML page in general, including editing, deletion, recording (record a user action on the page, such as clicking a link or button), but mainly is used for page binding. By binding the “bruce” node 1810 to “John” on the web page 1902, the word “John” is replaced with “Bruce” on the web page. The content author 1140 may select peer nodes to the “bruce” node 1810, which would then automatically replace “bruce” on the web page with the name of the peer node. Once the content author 1140 has completed binding all elements that need binding the content author may select the “publish” button 1824 to send the bound page to the server. The page extension may be changed to “.jsp”.

Thus the preferred embodiment of the invention provides a GUI, which allows an easy visual binding between nodes in a database and elements in a web page. The nodes in the database can dynamically update the elements in the web page.

In many situations, it is useful to embed another service chain inside an outer service chain by attaching it to an ovlist item (or ov). Examples are:

Double do loops, outer service chain reads through the parent group, inner service chain reads through child group for each parent node;

Inner service chain collects a list or table of data and pass to a list or table attribute of the destination tree node; and

Inner service chain collects the list of children nodes and pass to the destination tree node.

The power of the service chain comes from the fact that it works with “collections”. A collection means a collection name followed by a collection of name-value pairs representing recursive objects. Recursion occurs when the “value” portion of an name-value pair is itself a collection of name-value pairs. For example, a node is a collection with many attributes. Some of the attributes are compound attributes like a list or table, which are themselves collections.

| | |
|---|---|
| CollectionName: | // collection name is generally not used |

| | |
|---|---|
| Name0, value0 | |
| Name1, value1 | |
| Name2, value2 | // value2 is also a collection |
| \| | \| |

| | |
|---|---|
| \| | \| |

name20, value20
name2l, value2l

The simplest example of how this works is when a service chain reads from a source tree and sends the results to a destination tree. For a single link (non- repeating), one node is read at a time, and one node is written to at a time. Each execution of a service chain link transfers all or some of the attributes to the receiving tree node. A repeating link, on the other hand, transfers a whole group of nodes with he associated attributes to the destination tree. A group of nodes share the same parent and schema. Therefore the collection represented in this basic service chain action is a set of attributes attached to one node name. Since the node attributes can be complex (in case of list and table attributes), this results in having a collection in a collection.

| nodeName: | | // this nodeName is not used |
|---|---|---|
| | NODE_NAME, nodeName | // existing practice calls for an explicit |
| | | // NODE_NAME attribute |
| | attrib1, value1 | |

| | |
|---|---|
| attrib2, value2 | // value2 is a list attrib |

| | |
|---|---|
| \| | \| |

| | |
|---|---|
| \| | \| |

item 20, value20
item 21, value21

| | |
|---|---|
| attrib 3, value3 | // value3 is a table attrib |

| | |
|---|---|
| \| | \| |

row30, value30

| | |
|---|---|
| \| | \| |

| | |
|---|---|
| \| | \| |

col300, value300
col301, value301

In the preferred embodiment, there are two ways an service chain can pass a collection to the destination tree node. One is the URL simply reads the collection (e.g. table attribute) and passes directly to the ovlist item which matches a collection on the destination node: or, the ovlist item can have an embedded service chain attached to it to generate the collection.

The fact that it is possible to have repeating links adds another level of complexity, but it only adds one level of extension to the single link example. Instead of generating a single destination node, the repeating link generates a complete group of destination nodes (that are peer nodes). Therefore, the repeating link simple generates another type of collection: collection of nodes.

The wire room 1106 may be used by integration professionals 1136, such as supply chain professionals to set up exchanges between the company and any of its external partners. The wire room 1106 may be used to take care of both process and data format aspect of the integration task. The wire room may also be ideally suited for enterprise application integration (EAI) efforts, which aims to integrate multiple business applications within the enterprise. The wire room may also be geared for B2B integration via Internet document exchange or any http interactions. The binding between the content architect and a backend system and the binding between the content architect and an external partner are illustrated in FIG. 9 and discussed above in the description of FIG. 9.

The war room 1104 may be used by business managers 1134 and may serve as the control center for an enterprise system. The war room 1 104 provides the business manager with all relevant information in real time, allowing the business manager to be in charge of total monitoring and control capabilities. Non-programmer business managers can use this tool to re-allocate resources to optimize business transactions on the spot. An eCommerce cockpit may be a light configuration of the war room in one embodiment of the invention. The war room 1104 is used for administration and monitoring purposes. To use many of the administrative functions, the user may be required to log in as an administrator. The administrator password can be reset once inside the war room 1104. The war room 1104 may allow the administrator user to see multiple trees, both system level trees and projects based trees, where a projects tree contains definitions for all projects in the database, a systemUsers tree defines user ID and password, and where one tree for each project is defined in the database.

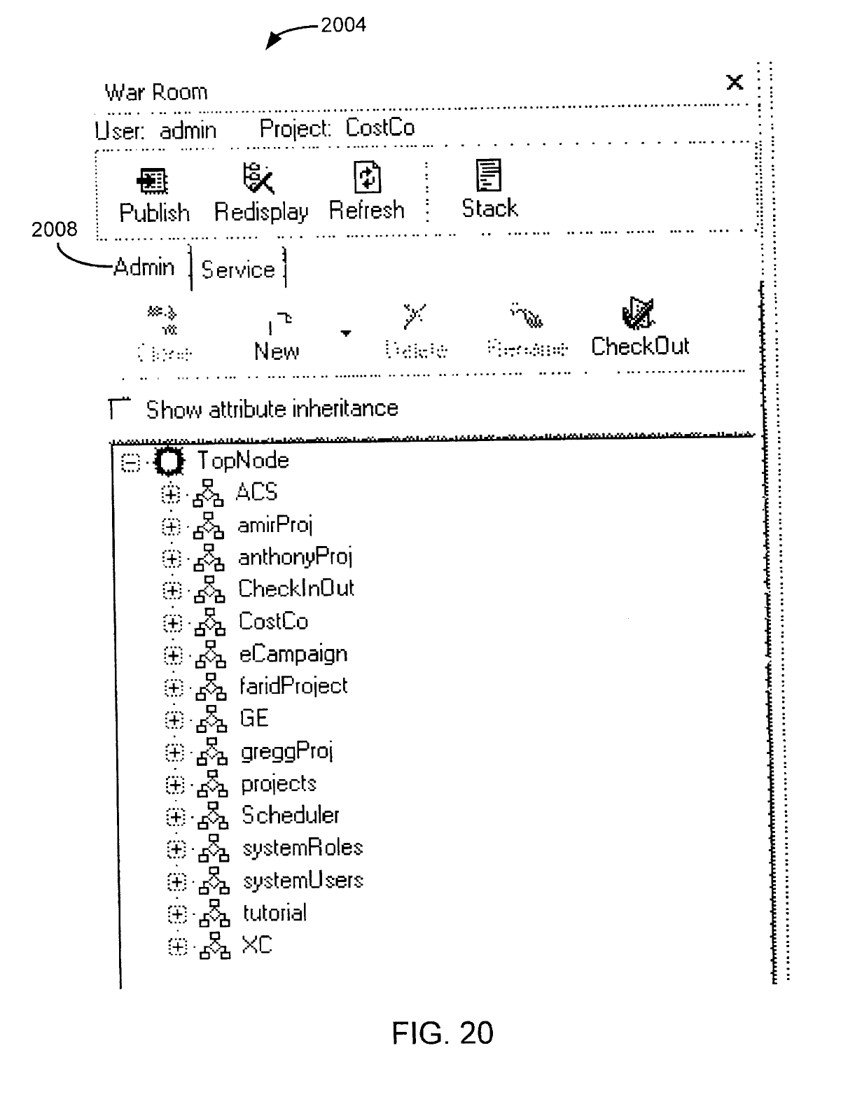

To facilitate understanding, FIG. 20 is an illustration of a war room GUI 2004 provided by a preferred embodiment of the invention. The administrative tab 2008 allows the business managers 1134 to add a user, add a project, and perform a stack dump, where the user and project are kept in data trees.

In the preferred embodiment, the URL may have parts, such as the protocol which may be one of the protocols discussed below, the host which may be the host name or IP, the project which may specify the project name keeping rule, the rule name which may specify the name of the rule, and the parameter which may specify input and output.

In the preferred embodiment, the rule engine 1020 uses a rule engine URL, with the following protocol. The rule engine URL has 4 parts

re://$host/$project/$ruleName?$parameter&parameter...

$host =host name or IP
$project=name of project containing the rule
$ruleName =a name of this rule
$parameter

INPUT - propertyname=XXX // XXX can be contained in““
For example: param1=”partsListing/part/”+($NODE_NAME)
OUTPUT - propertyname // no=value attached

A special input parameter for the rule engine is contextID
Syntax of value of contextID is same as $path in car: protocol. This
parameter automatically triggers car: processing and send result to
this rule engine.

For example: ContextID=″/partsListing/part”

Programming the rule engine is by large part simply Java coding. the Java code interacts with the framework environment via certain pre-build interfaces and can include some Javascript like syntax. The Javascript syntax is provided for very simple rule expressions.

A rule engine programming environment may be called up by pressing a rule button, which may be in the architect room GUI, type room GUI (service tab) or in the press room GUI. FIG. 21 is an example of a resulting rule GUI 2104. The rule GUI provides for the creation of a rule, the specification of input and output parameters for a rule, and select a project to which a rule belongs.

Auto Refresh

To provide an auto refresh, a targeted automatic update is executed when there is a dependency between a source tree and a destination tree and the source tree is modified is provided by the following process.

1. record the dependency in a special content architect tree called dependency tree

a. record the schema ID of the source tree node which will trigger the auto-refresh. The schema ID indicates which schema node the source tree node is cloned from. The schema node is equivalent to the Java class, where as instance node (cloned from schema node) is equivalent to Java object (instantiated from the Java class). The exact source node which triggers the auto-refresh is of course known at run time.

b. Record the destination node(s) that is (are) dependent on the source node. This only records the schema representation of the destination tree. The exact destination nodes affected will have to be computed at run time.

c. Record the service chain section containing the URL which reads the source node and populates the destination node via content binding. A service chain is involved between every pair of source and destination trees.

d. Record all the input variables (call iv in the service chain) as name-value pairs: (iv[n], value of iv[n]), where n starts from 0.

The value of iv[n] generally equals to parent.NODE_NAME, or parent.parent.NODE_NAME (or higher level of ancestry). This variable or variables indicates exactly which destination tree node needs to be populated by binding. The binding mechanism reads the identity of the parent or grandparent (or higher ancestors) to figure out which children node or nodes to populate.

2. when the source tree does change, the auto-refresh can either

a. set a dirty bit on the parent of the affected destination node(s). This will force the entire set of children nodes to be refreshed by re-executing the binding from the source tree.

b. Or do a direct update of the affected destination node(s).

3. finally, the auto-refresh mechanism has to find the affected destination tree nodes to set the dirty bit on their parent, or to do targeted refresh of the affected nodes.

a. Make use of the fact that destination tree passes its ancestor node name to sc (service chain) to trigger transfer of content from source to itself. The sc has the following input, output and URL (see section on service chain for details).

Iv[0]=parent.NODE_NAME (or parent.parent.NODE_NAME, etc)

URL=car:// . . . iv[0] . . . //iv[0] is somewhere in the path

ovlist //the output is bound to the destination tree

The relationship between the destination parent node and the newly updated source node is given in the URL. The steps are

i. Find the position of iv[n] with respect to the URL's end node (end node is the source tree node whose change will trigger the auto-refresh). The position will translate into

| iv position | value |
|---|---|
| . . ./iv[n] | Node name of changed source node |
| . . ./iv[n]/endNode | Node name of parent of changed source node |
| . . ./iv[n]/. . ./endNode | Node name of parent of parent of changed |
| | source node |

ii. value column indicates the node name(s) which define the destination tree path for the affected node.

iii. The node path position in the destination tree is indicated by the value corresponding to iv[n] (parent.NODE_NAME, or parent.parent.NODE_NAME, etc.).

iv. The node name and node path position together allows the auto-refresh mechanism to find exactly where in the destination tree it needs to update.

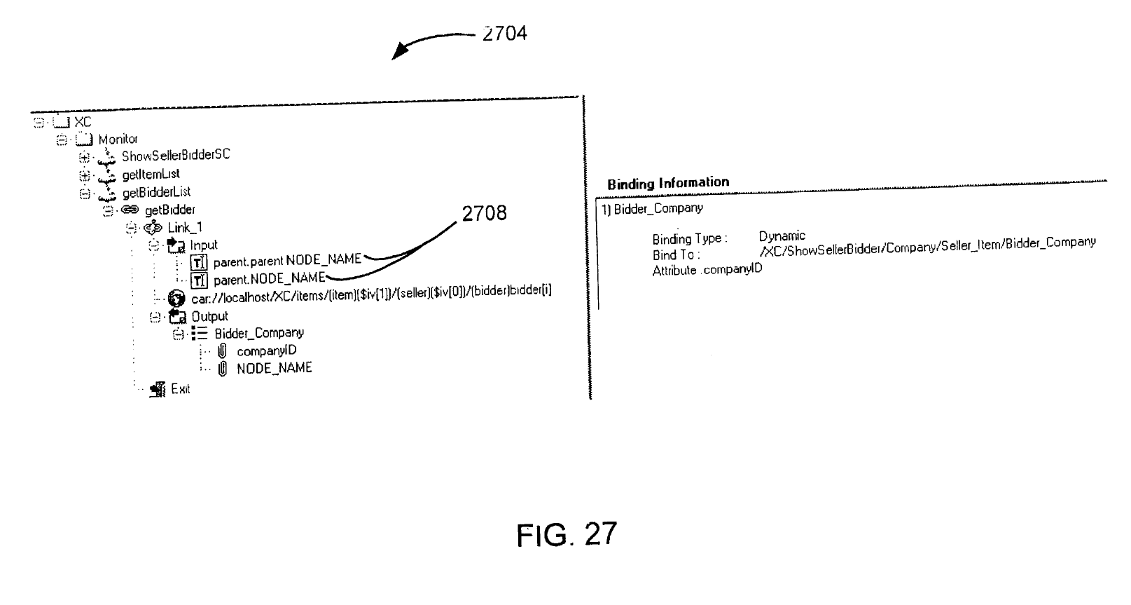

FIG. 27 is an example of a service chain that illustrates multiple level dependencies that transfers content from source to destination and requires the identification of both parent and grandparent of the destination node. This service chain 2704 reads from a source tree /XC/items/item/seller/bidder and writes to destination tree /XC/ShowSellerBidder/Company/Seller_item/Bidder Company via binding.

The end node in the source tree is “/XC/items/item/seller/bidder” is bidder. There are two levels of dependency indicated by two iv's 2708 in the sc, both parent.NODE_NAME and parent.parent.NODE_NAME.

During binding, these entries are added to the dependency tree:

1. schema ID of /XC/items/item/seller/bidder

2. the service chain section containing the URL—getBidderList/getBidder/Link1

3. two name-values pairs

iv[0]=parent.parent.NODE_NAME

iv[1]=parent.NODE_NAME

4. the destination tree:

/XC/ShowSellerBidder/Company/Seller_Item/Bidder_Company

Whenever the bidder node in the source tree “items” is changed, the dependency mechanism will look up the relevant destination tree nodes to set dirty bits on. When a bidder “PerfumeShop” is added to

/XC/items/Max for men/perfume connection, the relevant nodes and values are

| iv | Value (from source) | Matched to destination |
|---|---|---|
| iv[0] | Bidder.parent = | Bidder_Company.parent.parent = |
| | perfume connection | Company |
| iv[1] | Bidder.parent.parent = | Bidder_Company.parent = Seller_Item |
| | Max for men | |

The destination tree with schema:

“/XC/ShowSellerBidder/Company/Seller_Item/Bidder_Campany” will have bidder “PerfumeShop” added to /XC/ShowSellerBidder/perfume connection/Max for men.

Auto-Refresh Will:

1. Dirty bit on Max for men is set, because that is the parent node of the bound node—PerfumeShop.

2. Directly added the “PerfumeShop” node without affecting other children node on the destination tree under /XC/ShowSellerBidder/perfume connection/Max for men.

The same auto-refresh mechanism can be applied if the content source is actually a database instead of a standard content architect tree. This is because the relational wrapper behaves just like a tree. The relational wrapper is and behaves like a tree with multiple level of hierarchy, each representing one table in the database. The parent child relationship in the relational wrapper tree is equivalent to primary-secondary key relationship in the relational tables (or any joint operation between two tables in general). Applications in the framework both to read from and write to the database via this wrapper. Necessary SQL statements are automatically generated and stored in the wrapper. This is generally possible and does not require implementation details.

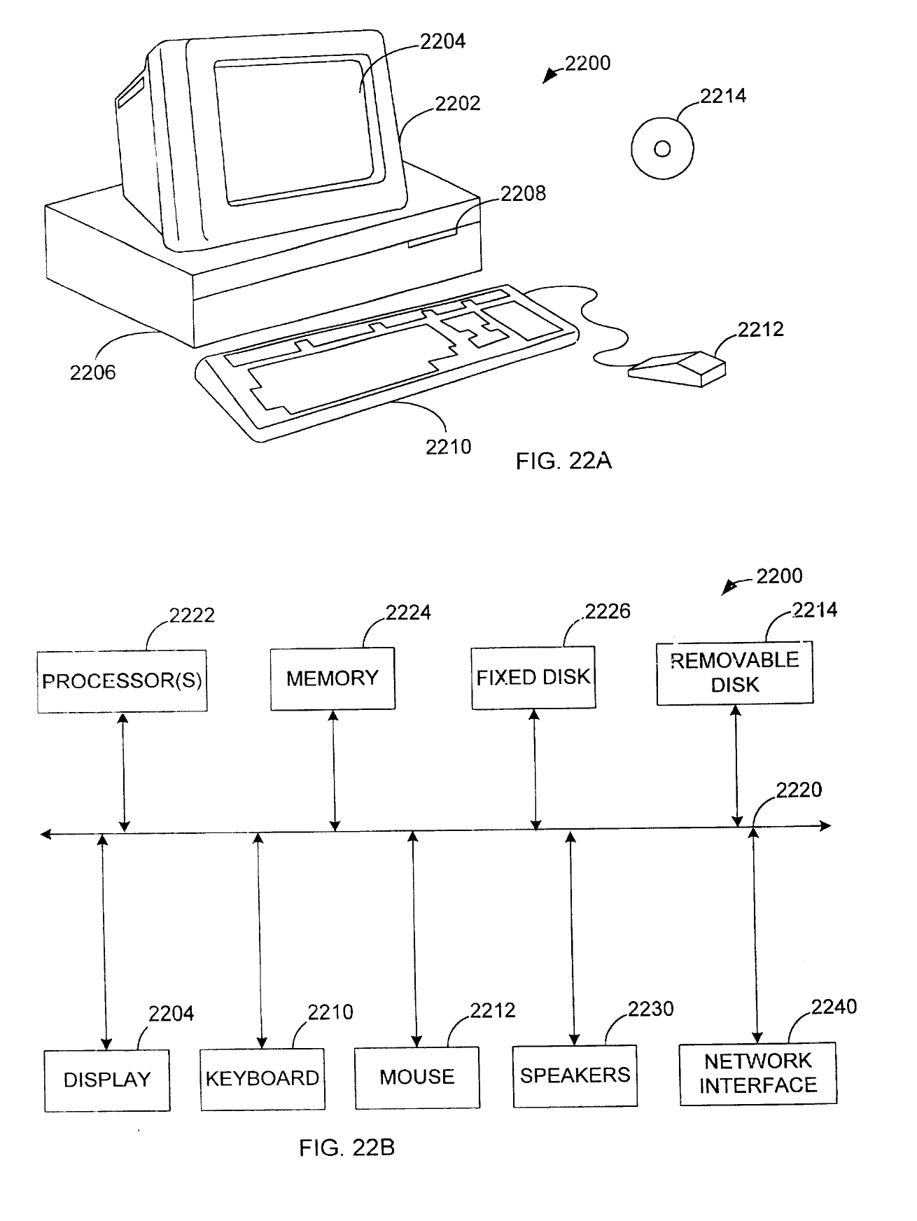

FIGS. 22A and 22B illustrate a computer system 2200, which forms part of an enterprise system and is suitable for implementing embodiments of the present invention. FIG. 22A shows one possible physical form of the computer system. Of course, the computer system may have many physical forms ranging from an integrated circuit, a printed circuit board, and a small handheld device up to a huge super computer. Computer system 2200 includes a monitor 2202, a display 2204, a housing 2206, a disk drive 2208, a keyboard 2210, and a mouse 2212. Disk 2214 is a computer-readable medium used to transfer data to and from computer system 2200. Preferably the computer system 2200 functions as a server, which stores the content architect.

FIG. 22B is an example of a block diagram for computer system 2200. Attached to system bus 2220 are a wide variety of subsystems. Processor(s) 2222 (also referred to as central processing units, or CPUs) are coupled to storage devices including memory 2224. Memory 2224 includes random access memory (RAM) and read-only memory (ROM). As is well known in the art, ROM acts to transfer data and instructions uni-directionally to the CPU and RAM is used typically to transfer data and instructions in a bidirectional manner. Both of these types of memories may include any suitable of the computer-readable media described below. A fixed disk 2226 is also coupled bi-directionally to CPU 2222; it provides additional data storage capacity and may also include any of the computer-readable media described below. Fixed disk 2226 may be used to store programs, data, and the like and is typically a secondary storage medium (such as a hard disk) that is slower than primary storage. It will be appreciated that the information retained within fixed disk 2226, may, in appropriate cases, be incorporated in standard fashion as virtual memory in memory 2224. Removable disk 2214 may take the form of any of the computer-readable media described below.

CPU 2222 is also coupled to a variety of input/output devices such as display 2204, keyboard 2210, mouse 2212, and speakers 2230. In general, an input/output device may be any of: video displays, track balls, mice, keyboards, microphones, 25 touch-sensitive displays, transducer card readers, magnetic or paper tape readers, tablets, styluses, voice or handwriting recognizers, biometrics readers, or other computers. CPU 2222 optionally may be coupled to another computer or telecommunications network using network interface 2240. With such a network interface, it is contemplated that the CPU might receive information from the network, or might output information to the network in the course of performing the above- described method steps. Furthermore, method embodiments of the present invention

The invention thus allows the management of disparate data sources providing a framework to allow the creation of a composite application that allows development of applications that can manipulate the integrated system. The invention provides a point and click interface which reduces or eliminates programming, providing an easier to use system. This easier to use system allows for a quicker development of business solutions, and especially ebusiness solutions. The invention helps to avoid development from scratch.

While this invention has been described in terms of several preferred embodiments, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

$contextID.size—number of objects (collections) returned by rule engine

$contextID.name—name of the context node.

se:

Search engine is used similarly to car. Basically, a search is done on a content architect tree.

se://domainname/nodepath/node?attrib1=value1&attrib2=value2

Search engine will return all nodes with attributes which match the search criteria. If multiple attribute values are specified, the logical operation is AND.

scrape:

The scraping protocol is captured automatically, not written into the URL node manually. The format is

scrape://domainname/page?input1=value1&input2=value2&output1&output

post:

To (http) post a document to a URL destination, use

Post://domainname/urlPath?input1=documentFileName

The effect is the same as if the web browser performed a post via a form submit.

email:

The user can email a message to a standard email address by

Email://name@domainname?from=fromAddress&subject=subject&text=text message

b. car://localhost/nodepath/node?listattr.ATTR_NAME—returns list attributes names in a string array

Sc:

Service chains are arranged in a flat list, not hierarchical directory. So nodepath is omitted.

Sc://domainname/scName?input1=value1&input2=value2&outputz &output2

Optionally, the designer may insert project name in front of the service chain name

Sc://domainname/projectName/scName?input1=value1&input2=value2&output1

Sc: uses same keywords as car: the keyword, NODE_NAME, needs to be wrapped in ($NODE-NAME) when used as an input parameter value, as in

Sc://localhost/projectName/scName?param1=($NODE_NAME)

re:

Rule engine is called out similarly as sc:, except the optional use of contextID as an input.

re://domainname/projectName/reName?contextID=contextValue&input1=value1&output1

Again, project name should be inserted.

Rule engine is often used in bag attribute (which may be in a table attribute) for the purpose of personalization. For example, a project may have

/xc/formTrees/itemSearchResult/sessionID.itemSearchReturnTable.bidAndAsk

Re: takes various keywords:

5. car://host/nodePath/<nodeValue>?listAttributeName, return

Name value pairs

6. car://host/nodePath/<nodeValue>?listAttributeName. ATTR_VALUE, return

AttribName, value array (“value1, value2, . . . ”)

Keywords for the car protocol structure are:

1. NODE_NAME

a. car://hostname/nodePath/schemaName[i] ?NODE_NAME returns the name of the i-th node of type schemaName under nodePath

2. parent

a. variants include parent.NODE_NAME, parent.attributeName, parent.listAttribName.itemName, parent.parent.NODE_NAME, etc.

3. schemaName

a. refer to the schema or group name of a node

b. car://hostname/nodePath/schemaName[i] returns i-th node in group schemaName

4. ATTR_VALUE

a. for list attributes only

b. car://localhost/nodepath/node?listattr.ATTR_VALUE—returns list attributes values in a string array

5. ATTR_NAME

a. for list attributes only may execute solely upon CPU 2222 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

### EXAMPLES

An example of protocol structures may be as follows:

car:

Content architect trees are read by their hierarchical node path, just like files in a directory. The various car: URL formats are shown below:

1. car://host/nodePath/<nodeValue>?input1=value1& . . .

2. car://host/nodePath/schemaNode[i], return

the i'th node in the node group represented by schemaNode.

3. car://host/nodePath/<nodeValue>[?output1&output2]

4. car://host/nodePath/<nodeValue>?listAttributeName.itemName

What is claimed is:

1. A computer readable medium containing program instructions for providing data to a web page, comprising:
computer readable code for allowing a user to form a hierarchical tree comprising a plurality of nodes;
computer readable code for allowing the user to select a node from the hierarchical tree, wherein the selected node has at least one attribute; and
computer readable code for allowing a user to bind the at least one attribute to the web page.

2. The computer readable medium, as recited in claim 1, wherein the selected node has peers and wherein the computer readable medium further comprises computer readable code for automatically binding the peers of the selected node to the web page.

3. The computer readable medium, as recited in claim 2, wherein the computer readable code for allowing a user to bind the at least one attribute to the web page, comprises:
computer readable code, which allows the use of point and click techniques to select a region on the web page;
computer readable code for displaying the at least one attribute of the selected node;
computer readable code which allows the use of point and click techniques to select the visually displayed at least one attribute of the selected node;
computer readable code which allows the use of point and click techniques to select a command to bind the at least one attribute of the selected node to the selected region of the web page.

4. The computer readable medium, as recited in claim 3, wherein the selected node has at least a second attribute, further comprising computer readable code for allowing a user to bind the at least second attribute to the web page, comprising:
wherein the computer readable code which allows the use of point and click techniques to select a region on the web page also allows the use of point and click techniques to select a second region of the web page;
wherein the computer readable code for displaying the at least one attribute of the selected node also displays the at least second attribute with the at least one attribute;
wherein the computer readable code which allows the use of point and click techniques to select the visually displayed at least one attribute of the selected node also allows the selection of the at least second attribute;
wherein the computer readable code which allows the use of point and click techniques to select a command to bind the at least one attribute of the selected node to the selected region of the web page also allows the binding of the at least second attribute of the selected node to the second selected region of the web page.

5. The computer readable medium, as recited in claim 4, wherein the peers of the selected node have an at least one attribute and the at least second attribute and wherein the computer readable code for automatically binding the peers of the selected node to the web page, comprises computer readable code for automatically binding the at least one attribute of the peers to the selected region of the web page and automatically binding the at least second attribute of the peers to the second selected region of the web page.

6. The computer readable medium, as recited in claim 5, wherein the computer readable code which allows the use of point and click techniques to select a region on the web, comprises computer readable code which allows the use of point and click techniques to select a region of a web page being displayed on a web browser.

7. The computer readable medium, as recited in claim 6, wherein the at least one attribute is a non-visual element.

8. The computer readable medium, as recited in claim 7, further comprising computer readable code for dynamically changing the web page when a node to which the web page is bound is changed.

9. The computer readable medium, as recited in claim 3, wherein the computer readable code which allows the use of point and click techniques to select a region on the web, comprises computer readable code which allows the use of point and click techniques to select a region of a web page being displayed on a web browser.

10. The computer readable medium, as recited in claim 1, further comprising computer readable code for dynamically changing the web page when the at least one attribute to which the web page is bound is changed.

11. A computer readable medium containing program instructions for managing a network of computers, comprising:
computer readable code for allowing a user to form a hierarchical tree comprising a plurality of nodes; and
computer readable code for allowing a user to bind nodes of the hierarchical tree.

12. The computer readable medium, as recited in claim 11, further comprising computer readable code for providing a plurality of links for at least one service chain, wherein the computer readable code for allowing the user to bind the nodes, comprises computer readable code for allowing a user to bind a node to a link of the plurality of links.

13. The computer readable medium, as recited in claim 12, wherein the computer readable code for allowing a user to bind the nodes, further comprises:
computer readable code which allows the use of point and click techniques to select a node from the plurality of nodes;
computer readable code which allows the use of point and click techniques to select a link from the plurality of links; and
computer readable code which allows the use of point and click techniques to select bind command that binds the selected link to the selected node.

14. The computer readable medium, as recited in claim 13, wherein the selected link has an output list with a plurality of items in the output list, and wherein the selected node has a plurality of attributes, wherein the computer readable code for allowing a user to bind the nodes further comprises computer readable code for outputting items in the output list of the selected link into the attributes of the selected node.

15. The computer readable medium, as recited in claim 14, further comprising computer readable code for reading data into the output list of the selected link from a data source.

16. The computer readable medium, as recited in claim 15, wherein the computer readable code for reading data into the output list of the selected link comprises computer code for performing a Uniform Resource Locator (URL) read of data from the data source to the selected link.

17. The computer readable medium, as recited in claim 16, wherein the selected node is a schema node.

18. The computer readable medium, as recited in claim 17, further comprising computer readable code for executing the link by generating a clone of the selected node to create an instance of the selected node and providing data from the link to the clone of the selected node.

19. The computer readable medium, as recited in claim 17, further comprising computer readable code for executing the link by overwriting an instance of the selected node and providing data from the link to the instance of the selected node.

20. The computer readable medium, as recited in claim 13, wherein the selected node is a schema node.
